(19) United States
(12) Patent Application Publication
(10) Pub. No.: US 2024/0306154 A1
(43) Pub. Date: Sep. 12, 2024

(54) USER EQUIPMENT AND METHOD FOR MULTIPLEXING UPLINK CONTROL INFORMATION

(71) Applicant: FG Innovation Company Limited, Tuen Mun (HK)

(72) Inventor: HAI-HAN WANG, Taipei (TW)

(21) Appl. No.: 18/272,715

(22) PCT Filed: Jan. 14, 2022
(86) PCT No.: PCT/CN2022/072008

§ 371 Date: Jul. 17, 2023

Related U.S. Application Data
(60) Provisional application No. 63/138,206, filed on Jan. 15, 2021.

(51) Int. Cl. H04W 72/21; H04L 1/1812; H04W 72/1268; H04W 72/231; H04W 72/563; H04W 76/20

(52) U.S. Cl. CPC H04W 72/21; H04L 1/1812; H04W 72/1268; H04W 72/231; H04W 72/563; H04W 76/20

(57) ABSTRACT

A UE and a method for handling multiplexing UCI are provided. The method receives an RRC configuration including a first PUCCH resource configuration and a second PUCCH resource configuration. The method obtains a first set of PUCCH resources in a first sub-slot and a second set of PUCCH resources in a second sub-slot, where the first sub-slot overlaps the second sub-slot. The method performs a first UCI multiplexing procedure after determining that a first PUCCH resource of the first set of PUCCH resources overlaps a second PUCCH resource of the second set of PUCCH resources and a timing constraint for multiplexing is satisfied. The first PUCCH resource is associated with transmission of first UCI. The first UCI multiplexing procedure includes selecting a third PUCCH resource from the second set of PUCCH resources and multiplexing the first UCI in the third PUCCH resource.

### CROSS-REFERENCE TO RELATED APPLICATION(S)

This application is a National Stage Application of International Patent Application Serial No. PCT/CN2022/072008, filed on Jan. 14, 2022, which claims the benefit of and priority to U.S. Provisional Patent Application Ser. No. 63/138,206, filed on Jan. 15, 2021, the contents of all of which are hereby incorporated herein fully by reference for all purposes.

### FIELD

The present disclosure is related to wireless communication, and specifically, to a method for multiplexing uplink control information (UCI) in cellular wireless communication networks.

### BACKGROUND

Some of the acronyms in the present disclosure are defined as follows and unless otherwise specified, the acronyms have the following meanings:

| Abbreviation | Full name |
|---|---|
| 3GPP | 3^{rd} Generation Partnership Project |
| 5G | 5^{th} Generation |
| 5GC | 5G Core |
| ACK | ACKnowledgment |
| BS | Base Station |
| BWP | Bandwidth Part |
| CA | Carrier Aggregation |
| CP | Cyclic Prefix |
| CQI | Channel Quality Indicator |
| CSI | Channel State Information |
| DC | Dual Connectivity |
| DCI | Downlink Control Information |
| DL | Downlink |
| E-UTRA(N) | Evolved Universal Terrestrial Radio |
| | Access (Network) |
| eMBB | enhanced Mobile Broadband |
| EN-DC | E-UTRA NR Dual Connectivity |
| EPC | Evolved Packet Core |
| gNB | Next Generation Node B |
| GSM | Global System for Mobile communications |
| HARQ | Hybrid Automatic Repeat reQuest |
| HP | High priority |
| ID | Identifier/Identity |
| IE | Information Element |
| LDPC | Low-Density Parity-Check |
| LP | Low priority |
| LTE | Long Term Evolution |
| MAC | Medium Access Control |
| MAC CE | MAC Control Element |
| MCG | Master Cell Group |
| mMTC | massive Machine-Type Communication |
| NACK | Negative ACK |
| NDI | New Data Indicator |
| NR | New Radio |
| NW | Network |
| OFDM | Orthogonal Frequency-Division |
| | Multiplexing |
| PCell | Primary Cell |
| PDCCH | Physical Downlink Control Channel |
| PDSCH | Physical Downlink Shared Channel |
| PDU | Protocol Data Unit |
| PMI | Precoding Matrix Index |
| PRACH | Physical Random Access Channel |
| PRI | PUCCH Resource Indicator |
| PSCell | Primary Secondary Cell/Primary SCG Cell |
| PUCCH | Physical Uplink Control Channel |
| PUSCH | Physical Uplink Shared Channel |
| RAN | Radio Access Network |
| RAT | Radio Access Technology |
| Rel-15 | 3GPP Release 15 |
| Rel-16 | 3GPP Release 16 |
| RI | Rank Index |
| RNTI | Radio Network Temporary Identifier |
| RRC | Radio Resource Control |
| SCell | Secondary Cell |
| SCG | Secondary Cell Group |
| SCS | Subcarrier Spacing |
| SI | System Information |
| SL | SideLink |
| SpCell | Special Cell |
| SR | Scheduling Request |
| SRS | Sounding Reference Signal |
| SSB | Synchronization Signal Block |
| TB | Transport Block |
| TBS | Transport Block Size |
| TS | Technical Specification |
| TX | Transmit/Transmission/Transmitter |
| UE | User Equipment |
| UL | Uplink |
| UMTS | Universal Mobile Telecommunications |
| | System |
| URLLC | Ultra-Reliable Low-Latency Communication |
| V2X | Vehicle-to-Everything |

With the tremendous growth in the number of connected devices and the rapid increase in user/network traffic volume, various efforts have been made to improve different aspects of wireless communication for the next-generation wireless communication system, such as the 5G NR, by improving data rate, latency, reliability, and mobility. The 5G NR system is designed to provide flexibility and configurability to optimize the network services and types, accommodating various use cases, such as eMBB, mMTC, and URLLC. However, as the demand for radio access continues to increase, there exists a need for further improvements in the art.

### SUMMARY

The present disclosure is related to a method for multiplexing UCI performed by a UE.

According to a first aspect of the present disclosure, a method performed by a UE for multiplexing UCI is provided. The method includes receiving an RRC configuration including a first PUCCH resource configuration and a second PUCCH resource configuration, the first PUCCH resource configuration including a first sub-slot configuration and the second PUCCH resource configuration including a second sub-slot configuration; obtaining a first set of PUCCH resources in a first sub-slot configured by the first sub-slot configuration; obtaining a second set of PUCCH resources in a second sub-slot configured by the second sub-slot configuration, the first sub-slot overlapping the second sub-slot; and performing a first UCI multiplexing procedure after determining that a first PUCCH resource of the first set of PUCCH resources overlaps a second PUCCH resource of the second set of PUCCH resources and a timing constraint for multiplexing is satisfied, the first PUCCH resource being associated with transmission of first UCI, wherein the first UCI multiplexing procedure includes selecting a third PUCCH resource from the second set of PUCCH resources, and multiplexing the first UCI in the third PUCCH resource.

According to an implementation of the first aspect, the first PUCCH resource configuration has a low priority, and the second PUCCH resource configuration has a high priority.

According to an implementation of the first aspect, the first UCI includes at least one of CSI, an SR with a low priority, and HARQ-ACK information associated with the first PUCCH resource configuration.

According to an implementation of the first aspect, the third PUCCH resource is associated with transmission of second UCI, and the second UCI includes at least one of an SR with a high priority and HARQ-ACK information associated with the second PUCCH resource configuration.

According to an implementation of the first aspect, the first set of PUCCH resources is obtained by performing a second UCI multiplexing procedure on a third set of PUCCH resources having a low priority in the first sub-slot.

According to an implementation of the first aspect, the second set of PUCCH resources is obtained by performing a second UCI multiplexing procedure on a third set of PUCCH resources having a high priority in the second sub-slot.

According to an implementation of the first aspect, the first PUCCH resource has a starting symbol within the second sub-slot.

According to an implementation of the first aspect, the first UCI multiplexing procedure is further performed on a fourth PUCCH resource of the first set of PUCCH resources, the fourth PUCCH resource being associated with transmission of third UCI and having a starting symbol within the second sub-slot, where the first UCI multiplexing procedure further includes determining whether to multiplex the third UCI in the third PUCCH resource based on whether the fourth PUCCH resource overlaps the third PUCCH resource.

According to an implementation of the first aspect, the method further includes obtaining a third set of PUCCH resources in a third sub-slot configured by the second sub-slot configuration, the third sub-slot being after the second sub-slot and overlapping the first sub-slot; and performing a second UCI multiplexing procedure after determining that a fourth PUCCH resource overlaps a fifth PUCCH resource of the third set of PUCCH resources, the fourth PUCCH resource being associated with transmission of third UCI; wherein the second UCI multiplexing procedure includes selecting a sixth PUCCH resource from the third set of PUCCH resources, the sixth PUCCH resource used for transmitting fourth UCI; and multiplexing the third UCI and the fourth UCI in the sixth PUCCH resource.

According to an implementation of the first aspect, the third UCI is not dropped or multiplexed in one of the second set of PUCCH resources after performing the first UCI multiplexing procedure.

According to an implementation of the first aspect, the third PUCCH resource is associated with transmission of second UCI, and the method further includes multiplexing the first UCI and the second UCI in a PUSCH resource associated with a low priority after determining that the third PUCCH resource overlaps the PUSCH resource.

According to an implementation of the first aspect, DCI scheduling the PUSCH resource indicates that the second UCI is multiplexed in the PUSCH resource.

According to an implementation of the first aspect, the timing constraint for multiplexing is satisfied in a case that a time duration between reception of DCI that schedules a fourth PUCCH resource of the second set of PUCCH resources and the first PUCCH resource is larger than a predefined time duration.

According to an implementation of the first aspect, the method further includes dropping the first UCI after determining that the first PUCCH resource of the first set of PUCCH resources overlaps the second PUCCH resource of the second set of PUCCH resources and the timing constraint for multiplexing is not satisfied.

According to a second aspect of the present disclosure, a UE for multiplexing UCI is provided. The UE includes at least one processor; and at least one memory coupled to the at least one processor, wherein the at least one memory stores one or more computer-executable instructions that, when executed by the at least one processor, cause the UE to receive an RRC configuration including a first PUCCH resource configuration and a second PUCCH resource configuration, the first PUCCH resource configuration including a first sub-slot configuration, and the second PUCCH resource configuration including a second sub-slot configuration; obtain a first set of PUCCH resources in a first sub-slot configured by the first sub-slot configuration; obtain a second set of PUCCH resources in a second sub-slot configured by the second sub-slot configuration, the first sub-slot overlapping the second sub-slot; and perform a first UCI multiplexing procedure after determining that a first PUCCH resource of the first set of PUCCH resources overlaps a second PUCCH resource of the second set of PUCCH resources and a timing constraint for multiplexing is satisfied, the first PUCCH resource being associated with transmission of first UCI, wherein the first UCI multiplexing procedure includes selecting a third PUCCH resource from the second set of PUCCH resources, and multiplexing the first UCI in the third PUCCH resource.

### BRIEF DESCRIPTION OF THE DRAWINGS

Aspects of the present disclosure are best understood from the following detailed description when read with the accompanying drawings. Various features are not drawn to scale. Dimensions of various features may be arbitrarily increased or reduced for clarity of discussion.

FIG. 1 is a timing diagram illustrating a PUCCH with a priority overlapping multiple non-overlapping PUCCHs with another priority, according to an example implementation of the present disclosure.

FIG. 2 is a timing diagram illustrating sub-slots configured by a first sub-slot configuration and a second sub-slot configuration, according to an example implementation of the present disclosure.

FIG. 3A is a schematic diagram illustrating a UCI multiplexing procedure for multiplexing UCIs of a high priority PUCCH and a low priority PUCCH, according to an example implementation of the present disclosure.

FIG. 3B is a schematic diagram illustrating a UCI multiplexing procedure for multiplexing UCIs of a high priority PUCCH and a low priority PUCCH, according to an example implementation of the present disclosure.

FIG. 3C is a schematic diagram illustrating a UCI multiplexing procedure for multiplexing UCIs of a high priority PUCCH and a low priority PUCCH, according to an example implementation of the present disclosure.

FIG. 4 is a timing diagram illustrating a low priority PUCCH overlapping a low priority DG PUSCH, where the low priority DG PUSCH overlaps a high priority CG PUSCH later than the low priority PUCCH, according to an example implementation of the present disclosure.

FIG. 5 is a timing diagram illustrating a low priority PUCCH overlapping a low priority DG PUSCH, where the low priority DG PUSCH overlaps a high priority CG PUSCH earlier than the low priority PUCCH, according to an example implementation of the present disclosure.

FIG. 6 is a timing diagram illustrating a high priority PUCCH overlapping a low priority DG PUSCH, where the low priority DG PUSCH overlaps a high priority CG PUSCH later than the low priority PUCCH, according to an example implementation of the present disclosure.

FIG. 7 is a timing diagram illustrating a high priority PUCCH overlapping a low priority DG PUSCH, where the low priority DG PUSCH overlaps a high priority CG PUSCH earlier than the low priority PUCCH, according to an example implementation of the present disclosure.

FIG. 8 is a timing diagram illustrating a high priority PUCCH overlapping a high priority CG PUSCH, a low priority PUCCH overlapping a low priority DG PUSCH, where the high priority CG PUSCH overlaps the low priority DG PUSCH later than the high priority PUCCH, and the high priority PUCCH does not overlap the low priority PUCCH later than the high priority CG PUSCH, according to an example implementation of the present disclosure.

FIG. 9 is a timing diagram illustrating a high priority PUCCH overlapping a high priority CG PUSCH, a low priority PUCCH overlapping a low priority DG PUSCH, where the high priority CG PUSCH overlaps the low priority DG PUSCH earlier than the high priority PUCCH, and the high priority PUCCH does not overlap the low priority PUCCH earlier than the high priority CG PUSCH, according to an example implementation of the present disclosure.

FIG. 10 is a timing diagram illustrating a high priority PUCCH overlapping a high priority CG PUSCH, where the high priority CG PUSCH overlaps a low priority DG PUSCH that does not overlap the high priority PUCCH, according to an example implementation of the present disclosure.

FIG. 11 is a timing diagram illustrating a high priority PUCCH overlapping a high priority CG PUSCH, where the high priority CG PUSCH overlaps a low priority DG PUSCH that overlaps the high priority PUCCH, according to an example implementation of the present disclosure.

FIG. 12 is a flowchart illustrating a method performed by a UE for multiplexing UCI, according to an example implementation of the present disclosure.

FIG. 13 is a block diagram illustrating a node for wireless communication according to an example implementation of the present disclosure.

### DESCRIPTION

The following contains specific information related to example implementations of the present disclosure. The drawings and their accompanying detailed description are merely directed to example implementations. However, the present disclosure is not limited to these example implementations. Other variations and implementations of the present disclosure will be obvious to those skilled in the art.

Unless noted otherwise, like or corresponding elements among the drawings may be indicated by like or corresponding reference designators. Moreover, the drawings in the present disclosure are generally not to scale, and are not intended to correspond to actual relative dimensions.

For the purposes of consistency and ease of understanding, like features may be identified (although, in some examples, not illustrated) by the same reference designators in the drawings. However, the features in different implementations may differ in other respects and may not be narrowly confined to the implementations illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for disclosing associated objects and represents that three relationships may exist such that A and/or B may indicate that A exists alone, A and B exist at the same time, or B exists alone. “A and/or B and/or C” may represent that at least one of A, B, and C exists. The character “/” generally represents that the associated objects are in an “or” relationship.

The terms “if”, “in a case that”, “when”, “after”, “upon”, and “once” may be used interchangeably.

For the purposes of explanation and non-limitation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or using one or more Digital Signal Processors (DSPs). Although some of the disclosed implementations are oriented to software installed and executing on computer hardware, alternative example implementations implemented as firmware, as hardware, or as a combination of hardware and software are well within the scope of the present disclosure.

The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) may typically include at least one Base Station (BS), at least one UE, and one or more optional network elements that provide connection within a network. The UE may communicate with the network such as a Core Network (CN), an Evolved Packet Core (EPC) network, an Evolved Universal Terrestrial Radio Access Network (E-UTRAN), a Next-Generation Core (NGC), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM that is often referred to as 2G), GSM Enhanced Data rates for GSM Evolution (EDGE) Radio Access Network (GERAN), General Packet Radio Service (GPRS), Universal Mobile Telecommunication System (UMTS that is often referred to as 3G) based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a Radio Network Controller (RNC) in UMTS, a Base Station Controller (BSC) in the GSM/GERAN, a next-generation eNB (ng-eNB) in an Evolved Universal Terrestrial Radio Access (E-UTRA) BS in connection with 5GC, a next-generation Node B (gNB) in the 5G RAN (or in the 5G Access Network (5G-AN)), or any other apparatus capable of controlling radio communication and managing radio resources within a cell. The BS may serve one or more UEs via a radio interface.

The BS may be operable to provide radio coverage to a specific geographical area using a plurality of cells included in the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the downlink (DL) and optionally UL resources to at least one UE within its radio coverage for DL and optionally UL packet transmissions. The BS may communicate with one or more UEs in the radio communication system via the plurality of cells.

A cell may allocate Sidelink (SL) resources for supporting Proximity Service (ProSe), LTE SL services, and/or LTE/NR Vehicle-to-Everything (V2X) service. Each cell may have overlapped coverage areas with other cells. In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), comprising of the SpCell and optionally one or more Secondary Cells (SCells). An SCG may refer to a group of serving cells associated with the Secondary Node (SN), including the SpCell and optionally one or more SCells.

As disclosed previously, the frame structure for NR supports flexible configurations for accommodating various next generation (e.g., 5G) communication requirements such as eMBB, mMTC, and URLLC, while fulfilling high reliability, high data rate and low latency requirements. The OFDM technology in the 3GPP may serve as a baseline for an NR waveform. The scalable OFDM numerology such as adaptive sub-carrier spacing, channel bandwidth, and CP may also be used.

Two coding schemes are considered for NR, specifically LDPC code and Polar Code. The coding scheme adaption may be configured based on channel conditions and/or service applications.

At least DL transmission data, a guard period, and an UL transmission data should be included in a transmission time interval (TTI) of a single NR frame. The respective portions of the DL transmission data, the guard period, and the UL transmission data should also be configurable based on, for example, the network dynamics of NR. Sidelink resources may also be provided in an NR frame to support ProSe services, V2X services (e.g., E-UTRA V2X sidelink communication services) or sidelink services (e.g., NR sidelink communication services). In contrast, sidelink resources may also be provided in an E-UTRA frame to support ProSe services, V2X services (e.g., E-UTRA V2X sidelink communication services) or sidelink services (e.g., NR sidelink communication services).

Any two or more than two of the following sentences, paragraphs, (sub)-bullets, points, actions, behaviors, terms, alternatives, aspects, examples, or claims described in the following disclosure may be combined logically, reasonably, and properly to form a specific method.

Any sentence, paragraph, (sub)-bullet, point, action, behaviors, terms, alternatives, aspects, examples, or claims described in the following disclosure may be implemented independently and separately to form a specific method.

Dependency, e.g., “based on”, “more specifically”, “preferably”, “In one embodiment”, “In some implementations”, “In one alternative”, “In one example”, “In one aspect”, or etc., in the following disclosure is just one possible example which would not restrict the specific method.

Example descriptions of some selected terms used in this disclosure are given as follows.

Cell: A cell may be a radio network object that may be uniquely identified by a UE from a (cell) identification that is broadcast over a geographical area from one UTRAN Access Point. The Cell may be either in an FDD or a TDD mode.

Serving cell: For a UE in an RRC_CONNECTED state that is not configured with CA or DC, there may be only one serving cell, which may be referred to as a PCell. For a UE in the RRC_CONNECTED state that is configured with CA or DC, the term “serving cells” may be used to denote a set of cells including SpCell(s) and all SCells. For example, The serving cell may be a Pcell, a PSCell, or an Scell, as described, e.g., in the 3GPP TS 38.331.

HARQ: HARQ may be a scheme that combines an ARQ error control mechanism and FEC coding in which unsuccessful attempts (transmissions) are used in FEC decoding instead of being discarded. HARQ may be a functionality that ensures delivery between peer entities at Layer 1 (i.e., Physical Layer). A single HARQ process supports one TB when the physical layer is not configured for DL/UL spatial multiplexing, and a single HARQ process supports one or multiple TBs when the physical layer is configured for DL/UL spatial multiplexing. There is one HARQ entity per serving cell. Each HARQ entity supports a parallel (number) of DL and UL HARQ processes.

HARQ information: HARQ information for DL-SCH or for UL-SCH transmissions may include NDI, TBS, RV, and HARQ process ID.

HARQ-ACK: A HARQ-ACK feedback may be used to indicate whether a HARQ process is successfully received. A HARQ-ACK information bit value of 0 may represent a NACK while a HARQ-ACK information bit value of 1 may represent a positive ACK.

CSI: CSI may include CQIs as well as MIMO-related feedback. The MIMO-related feedback may include RIs and PMI, etc.

SR: An SR may be used by a UE to request UL resource(s).

### Logical Channel Prioritization

Table 1 illustrates a UE behavior associated with a logical channel prioritization.

TABLE 1
3GPP TS 38.321 V16.1.0

```
When the MAC entity is configured with lch-basedPrioritization, for each uplink grant
whose associated PUSCH can be transmitted by lower layers, the MAC entity shall:
  1> if this uplink grant is addressed to CS-RNTI with NDI = 1 or C-RNTI:
    2> if there is no overlapping PUSCH duration of a configured uplink grant which was
```

not already de-prioritized, in the same BWP whose priority is higher than the
priority of the uplink grant; and

2> if there is no overlapping PUCCH resource with an SR transmission which was not

```
already de-prioritized and the priority of the logical channel that triggered the SR is
higher than the priority of the uplink grant:
3> consider this uplink grant as a prioritized uplink grant;
3> consider the other overlapping uplink grant(s), if any, as a de-prioritized uplink
  grant(s);
3> consider the other overlapping SR transmission(s), if any, as a de-prioritized SR
  transmission(s).
```

```
  1> else if this uplink grant is a configured uplink grant:
    2> if there is no overlapping PUSCH duration of another configured uplink grant
```

which was not already de-prioritized, in the same BWP, whose priority is higher
than the priority of the uplink grant; and

2> if there is no overlapping PUSCH duration of an uplink grant addressed to CS-

RNTI with NDI = 1 or C-RNTI which was not already de-prioritized, in the same
BWP, whose priority is higher than or equal to the priority of the uplink grant; and

2> if there is no overlapping PUCCH resource with an SR transmission which was not

```
already de-prioritized and the priority of the logical channel that triggered the SR is
higher than the priority of the uplink grant:
3> consider this uplink grant as a prioritized uplink grant;
3> consider the other overlapping uplink grant(s), if any, as a de-prioritized uplink
  grant(s);
3> consider the other overlapping SR transmission(s), if any, as a de-prioritized SR
  transmission(s).
```

### T_{proc,2}

T_{proc,2} may be a time duration (or period) for a PUSCH preparation (procedure). T_{proc,2} may be calculated according to Equation (1) below.

$${T}_{proc , 2} = max ( ( {N}_{2} + {d}_{2 , 1} ) ( 2048 + 144 ) \cdot κ \cdot {2}^{- μ} \cdot {T}_{C} , {d}_{2 , 2} ) \qquad Equation ( 1 )$$

The notations used in Equation (1) are described in TS 38 series specifications. For example, N₂ may be based on UE processing capability. μ may correspond to one of (μ_{DL}, μ_{UL}) resulting with the largest T_{proc,2}. μ_{DL} may correspond to the subcarrier spacing of the downlink channel with which the PDCCH carrying the DCI scheduling the PUSCH was transmitted. μ_{UL} may correspond to the subcarrier spacing of the uplink channel with which the PUSCH is to be transmitted. κ and T_{C} may be determined, as described in TS 38.211.

If the first symbol of the PUSCH allocation includes (or consists of) DM-RS only, d_{2,1} may be 0; otherwise d_{2,1} may be 1.

If the UE is configured with multiple active component carriers, the first uplink symbol in the PUSCH allocation may include the effect of timing difference between component carriers as described in TS 38.133.

If the scheduling DCI triggers a BWP switching, d_{2,2} may equal to the switching time as defined in TS 38.133; otherwise d_{2,2} may be 0.

### T_{proc,3}

T_{proc,3} may be a time duration (or period) associated with reporting (or multiplexing) the HARQ-ACK information. T_{proc,3} may be calculated according to Equation (2) below.

$${T}_{proc , 3} = {N}_{3} \cdot ( 2048 + 144 ) \cdot κ \cdot {2}^{- μ} \cdot {T}_{C} \qquad Equation ( 2 )$$

The notations used in Equation (2) are described in TS 38 series specifications. For example, κ and T_{C} are defined in TS 38.211. μ may correspond to the smallest SCS configuration among the SCS configurations of the PDCCHs providing the DCI formats and the SCS configuration of the PUCCH. If processing Type2Enabled of PDSCH-ServingCellConfig is set to enable for the serving cell with the second DCI format and for all serving cells with corresponding HARQ-ACK information multiplexed in the PUCCH transmission in the slot, N₃=3 for μ=0, N₃=4.5 for μ=1, and N₃=9 for μ=2; otherwise, N₃=8 for μ=0, N₃=10 for μ=1, N₃=17 for μ=2, and N₃=20 for μ=3.

### PUCCH Overriding Timeline (Constraint)

If a UE detects a first DCI format indicating a first resource for a PUCCH transmission with corresponding HARQ-ACK information in a slot and also detects (e.g., at a later time) a second DCI format indicating a second resource for a PUCCH transmission with corresponding HARQ-ACK information in the slot, the UE may not (expect to) multiplex HARQ-ACK information corresponding to the second DCI format in a PUCCH resource in the slot if the PDCCH reception that includes the second DCI format is not earlier than a specific time duration from the beginning (or start) of a first symbol of the first resource. The specific time duration may be determined as N₃·(2048+144)·κ·2^{-μ}·T_{C}.

### UCI Multiplexing Timeline (Constraint)

If a UE attempts to transmit a group of overlapping PUCCHs (e.g., PUCCHs overlapping each other) in a slot or to transmit overlapping PUCCH(s) and PUSCH(s) in a slot and, when applicable (e.g., as described in Subclauses 9.2.5.1 and 9.2.5.2 of TS 38.213), the UE may be configured to multiplex different UCI types in one PUCCH, and at least one of the overlapping PUCCH(s) or PUSCH(s) is in response to a DCI format detection by the UE, the UE may multiplex all corresponding UCI types if the following conditions are met.

If one of the PUCCH transmissions or PUSCH transmissions is in response to a DCI format detection by the UE, the UE may expect that the first symbol S₀ of the earliest PUCCH or PUSCH, among a group of overlapping PUCCH(s) and PUSCH(s) (e.g., PUCCH(s) overlapping PUSCH(s)) in the slot, satisfies at least one of the following timeline conditions.

Condition 1: S₀ is not before a symbol with a CP starting after T_{proc,1}^{mux} after a last symbol of any corresponding PDSCH. T_{proc,1}^{mux} is given by the maximum of {T_{proc,1}^{mux}, . . . ,T_{proc,1}^{mux,i}, . . . }. For the i-th PDSCH with corresponding HARQ-ACK transmission on a PUCCH which is in the group of overlapping PUCCH(s) and PUSCH(s), T_{proc,1}^{mux,i}=(N₁+d_{1,1}+1)·(2048+144)·κ·2^{-μ}·T_{C}. N₁, d_{1,1}, κ, μ, and T_{C} may be determined as described in TS 38 series specifications (e.g., TS 38.211, TS 38.214). For example, d_{1,1} may be selected for the i-th PDSCH. N₁ may be selected based on the UE PDSCH processing capability of the i-th PDSCH and SCS configuration μ. μ may correspond to the smallest SCS configuration among the SCS configurations used for the PDCCH scheduling the i-th PDSCH, the i-th PDSCH, the PUCCH with corresponding HARQ-ACK transmission for i-th PDSCH, and all PUSCHs in the group of overlapping PUCCH(s) and PUSCH(s).

Condition 2: S₀ is not before a symbol with a CP starting after T_{proc,release}^{mux} after a last symbol of any corresponding SPS PDSCH release. T_{proc,release}^{mux} is determined as the maximum of {T_{proc,release}^{mux,1}, . . . ,T_{proc,release}^{mux,i}, . . . }. For the i-th PDCCH providing the SPS PDSCH release with corresponding HARQ-ACK transmission on a PUCCH which is in the group of overlapping PUCCH(s) and PUSCH(s), T_{proc,release}^{mux,i}=(N+1)·(2048+144)·κ·2^{-μ}·T_{C}·N, κ, μ, and T_{C} may be determined as described in TS 38 series specifications (e.g., TS 38.211, TS 38.214). For example, N may be selected based on the UE PDSCH processing capability of the i-th SPS PDSCH release and SCS configuration μ. μ may correspond to the smallest SCS configuration among the SCS configurations used for the PDCCH providing the i-th SPS PDSCH release, the PUCCH with corresponding HARQ-ACK transmission for i-th SPS PDSCH release, and all PUSCHs in the group of overlapping PUCCH(s) and PUSCH(s).

Condition 3: if there is no aperiodic CSI report multiplexed in a PUSCH in the group of overlapping PUCCH(s) and PUSCH(s), S₀ is not before a symbol with a CP starting after T_{proc,2}^{mux} after a last symbol of:
any PDCCH with the DCI format scheduling an overlapping PUSCH, and
any PDCCH scheduling a PDSCH (or SPS PDSCH release) with corresponding HARQ-ACK information in an overlapping PUCCH in the slot

If there is at least one PUSCH in the group of overlapping PUCCH(s) and PUSCH(s), T_{proc,2}^{mux} is determined as the maximum of {T_{proc,2}^{mux,1}, . . . , T_{proc,2}^{mux,i}, . . . }. For the i-th PUSCH which is in the group of overlapping PUCCH(s) and PUSCH(s), T_{proc,2}^{mux,i}=max(d_{2,2}, (N₂+d_{2,1}+1)·(2048+144)·κ·2^{-μ}·T_{C}). N₂, d_{2,1}, d_{2,2}, κ, μ, and T_{C} may be determined as described in TS 38 series specifications (e.g., TS 38.211, TS 38.214). For example, d_{2,1} and d_{2,2} may be selected for the i-th PUSCH. N₂ may be selected based on the UE PUSCH processing capability of the i-th PUSCH and SCS configuration μ. μ may correspond to the smallest SCS configuration among the SCS configurations used for the PDCCH scheduling the i-th PUSCH, the PDCCHs scheduling the PDSCHs with corresponding HARQ-ACK transmission on a PUCCH which is in the group of overlapping PUCCH(s) and PUSCH(s), and all PUSCHs in the group of overlapping PUCCH(s) and PUSCH(s).

If there is no PUSCH in the group of overlapping PUCCH(s) and PUSCH(s), T_{proc,2}^{mux} is determined as the maximum of {T_{proc,2}^{mux,1}, . . . , T_{proc,2}^{mux,i}, . . . }. For the i-th PDSCH with corresponding HARQ-ACK transmission on a PUCCH which is in the group of overlapping PUCCHs, T_{proc,2}^{mux,i}(N₂+1)·(2048+144)·κ·2^{-μ}·T_{C}. N₂, κ, μ, and T_{C} may be determined as described in TS 38 series specifications (e.g., TS 38.211, TS 38.214). For example, N₂ may be selected based on the UE PUSCH processing capability of the PUCCH serving cell if configured. N₂ may be selected based on the UE PUSCH processing capability 1, if PUSCH processing capability is not configured for the PUCCH serving cell. μ may be selected based on the smallest SCS configuration between the SCS configuration used for the PDCCH scheduling the i-th PDSCH with corresponding HARQ-ACK transmission on a PUCCH which is in the group of overlapping PUCCHs, and the SCS configuration for the PUCCH serving cell.

Condition 4: if there is an aperiodic CSI report multiplexed in a PUSCH in the group of overlapping PUCCH(s) and PUSCH(s), S₀ is not before a symbol with a CP starting after TT_{proc,CSI}^{mux}=max(d_{2,2}, (Z+d)·(2048+144)·κ·2^{-μ}·T_{C}) after a last symbol of
any PDCCH with the DCI format scheduling an overlapping PUSCH, and
any PDCCH scheduling a PDSCH (or SPS PDSCH release) with corresponding HARQ-ACK information in an overlapping PUCCH in the slot
d_{2,2}, Z, d, K, μ, and T_{C} may be determined as described in TS 38 series specifications (e.g., TS 38.211, TS 38.214). For example, u may correspond to the smallest SCS configuration among the SCS configurations of the PDCCHs, the smallest SCS configuration for the group of the overlapping PUSCHs, and the smallest SCS configuration of CSI-RS associated with the DCI format scheduling the PUSCH with the multiplexed aperiodic CSI report. d=2 for μ=0,1, d=3 for μ=2, and d=4 for μ=3.

In the NR system, multiple types of services (e.g., URLLC, eMBB) may be supported in a cell, each type of service may have different latency and reliability requirements. When a UE has both eMBB and URLLC traffics, it is possible that a PUSCH (or PUCCH) transmission for the eMBB traffic is on-going when the PUSCH transmission for the URLLC traffic occurs. To transmit the PUSCH for the URLLC traffic, the PUSCH (or PUCCH) transmission for the eMBB traffic may be cancelled to ensure the latency requirement of the PUSCH transmission for the URLLC traffic. In the situation that the PUCCH transmission carrying HARQ-ACK information is cancelled, a gNB may re-schedule the corresponding PDSCH, which may impact the system capacity (e.g., since the eMBB PDSCH may consume a large amount of radio resources). Therefore, when a high priority UL channel for the URLLC traffic overlaps a low priority PUCCH carrying HARQ-ACK information for the eMBB traffic, there may be a need to consider a mechanism for multiplexing the HARQ-ACK information for the eMBB traffic in the high priority UL channel for the URLLC traffic.

In Rel-16 of the 3GPP TS for NR, a UE may be configured with two HARQ-ACK codebooks.

If the UE is provided with the pdsch-HARQ-ACK-Codebook-List, the UE may be indicated by pdsch-HARQ-ACK-Codebook-List to generate one or two HARQ-ACK codebooks.

If the UE is indicated to generate one HARQ-ACK codebook, the HARQ-ACK codebook may be associated with a PUCCH with a (physical layer) priority index 0. If the UE is provided with the pdsch-HARQ-ACK-Codebook-List, the UE may only multiplex HARQ-ACK information associated with the same priority index in the same HARQ-ACK codebook.

If the UE is indicated to generate two HARQ-ACK codebooks, a first HARQ-ACK codebook may be associated with a PUCCH having a priority index 0 (e.g., low priority) and a second HARQ-ACK codebook may be associated with a PUCCH having a priority index 1 (e.g., high priority). The UE may be provided with {first PIC (′H-Config, first UCI-OnPUSCH, first PDSCH-code BlockGroup Transmission} by {PUCCHConfigurationList, UCI-OnPUSCH-List, PDSCH-CodeBlockGroupTransmission-List}, respectively, to use with the first HARQ-ACK codebook. The UE may be provided with {second PUCCH-Config, second UCI-OnPUSCH, second PDSCH-codeBlockGroup Transmission} by {PUCCHConfigurationList, UCI-OnPUSCH-List, PDSCH-CodeBlockGroupTransmission-List}, respectively, to use with the second HARQ-ACK codebook.

If the UE is provided with subslotLengthForPUCCH-r16 for a PUCCH-Config, a slot for a PUCCH transmission associated with the PUCCH-Config may include a number of symbols indicated by the subslotLengthForPUCCH-r16, and the PUCCH transmission may be referred to as a sub-slot-based PUCCH transmission.

In Rel-16 of the 3GPP TS for NR, due to the introduction of intra-UE prioritization, a low priority HARQ-ACK PUCCH may be cancelled (or dropped) if the UE is scheduled with a high priority PUSCH (or PUCCH) overlapping the low priority HARQ-ACK PUCCH. In addition, the low priority PUSCH may be canceled when a high priority PUCCH overlaps the low priority PUSCH. It is possible that a low priority HARQ-ACK codebook multiplexed in the low priority PUSCH is cancelled in response to the cancelation of the low priority PUSCH.

To increase spectral efficiency, there may be a need to consider mechanisms for multiplexing low priority HARQ-ACK codebook(s) of a low priority PUCCH and high priority HARQ-ACK codebook(s) and high priority SR(s) of a high priority PUCCH in a PUCCH when the low priority PUCCH overlaps the high priority PUCCH.

There may be a need to consider mechanisms for multiplexing low priority HARQ-ACK codebook(s) of a low priority PUCCH and high priority HARQ-ACK codebook(s) and high priority SR(s) of a high priority PUCCH in a low priority PUSCH (or a high priority PUSCH) when the low priority PUSCH (or the high priority PUSCH) overlaps the low priority PUCCH and the high priority PUCCH.

There may be a need to consider whether to allow a gNB to perform a specific operation (e.g., schedule uplink channels resulting in one PUSCH (or PUCCH) overlapping other PUCCH(s) (or PUSCH(s))). For example, the gNB may be allowed to schedule a PUCCH for a low priority HARQ-ACK codebook (e.g., without scheduling restriction on the PUCCH for a low priority HARQ-ACK codebook) to overlap PUCCH(s) for a high priority HARQ-ACK codebook, so that the latency of the high priority HARQ-ACK codebook may be satisfied. If the specific operation is not allowed, the PUCCH for the low priority HARQ-ACK codebook may (have to) be scheduled with a shorter length such that the PUCCH for the low priority HARQ-ACK codebook will not overlap two PUCCHs for the high priority HARQ-ACK codebook in different sub-slots. If the specific operation is not allowed and the gNB already scheduled a PUCCH for the high priority HARQ-ACK codebook overlapping a PUCCH for the low priority HARQ-ACK codebook, the gNB may not be able to schedule another PUCCH for the high priority HARQ-ACK codebook overlapping the PUCCH for the low priority HARQ-ACK codebook.

In Rel-15 and Rel-16 NR, different PUCCHs may be configured with different starting symbols in a slot. PUSCHs may also be scheduled (or configured) with different starting symbols in the slot. A set of PUCCH resources may be defined and a (UCI) multiplexing procedure may perform the following steps iteratively on the set of PUCCH resources.

First, a first PUCCH with the earliest starting symbol and the longest duration in the slot is determined (or selected) from the set of PUCCH resources. Accordingly, a first group of PUCCHs overlapping the first PUCCH (if any) is determined from the set of PUCCH resources.

Second, a second PUCCH (may be the same as or different from the first PUCCH) carrying multiplexed UCIs of the first PUCCH and the first group of PUCCHs is determined (or selected) from the first PUCCH and the first group of PUCCHs. It should be noted that PUCCH(s) with UCI(s) multiplexed in the second PUCCH is/are excluded from the set of PUCCH resources.

Third, a second group of PUCCHs overlapping the second PUCCH (if any) is determined from the remaining PUCCH resources of the set of PUCCH resources.

Fourth, a third PUCCH (may be the same as or different from the second PUCCH) carrying multiplexed UCIs of the second PUCCH and the second group of PUCCHs is determined (or selected) from the second PUCCH and the second group of PUCCHs. It should be noted that PUCCH(s) with UCI(s) multiplexed in the third PUCCH is/are excluded from the set of PUCCH resources.

The multiplexing procedure may be performed iteratively until (at most) two non-overlapping PUCCHs are determined.

When overlapping PUCCHs include a PUCCH for a HARQ-ACK feedback for scheduled PDSCH(s), the second PUCCH (or third PUCCH) may be selected from a PUCCH resource set from up to 4 PUCCH resource sets configured for the HARQ-ACK. The second PUCCH (or the third PUCCH) may be selected based on the PRI from PUCCH resources in a PUCCH resource set. The PUCCH resource set may be determined as follows.

If the UE transmits O_{UCI} UCI information bits that include the HARQ-ACK information bits, the UE may determine (or select) the PUCCH resource set to be one of the following, where the O_{UCI} may be the total payload size of multiplexed UCI(s).
a first set of PUCCH resources with pucch-ResourceSetId=0, if O_{UCI}≤2 and the UCI information bits include 1 or 2 HARQ-ACK information bits, and a positive (or negative SR) on one SR transmission occasion if transmission of HARQ-ACK information and transmission of SR occur simultaneously.
a second set of PUCCH resources with pucch-ResourceSetId=1, if pucch-ResourceSetId=1 is provided by higher layers, and if 2<O_{UCI}≤N₂. N₂ may be equal to maxPayloadSize if maxPayloadSize is provided for the PUCCH resource set with pucch-ResourceSetId=1; otherwise N₂ may be equal to 1706.
a third set of PUCCH resources with pucch-ResourceSetId=2, if pucch-ResourceSetId=2 is provided by higher layers, and if N₂<O_{UCI}≤N₃. N₃ may be equal to maxPayloadSize if maxPayloadSize is provided for the PUCCH resource set with pucch-ResourceSetId=2; otherwise N₃ may be equal to 1706.
a fourth set of PUCCH resources with pucch-ResourceSetId=3, if pucch-ResourceSetId=3 is provided by higher layers, and if N₃<O_{UCI}≤1706.

After the multiplexed UCIs and the PUCCH carrying the multiplexed UCIs are determined, the UE may multiplex the multiplexed UCIs in a PUSCH if the PUCCH carrying the multiplexed UCIs overlaps the PUSCH in the time domain.

In addition, the scheduling made by the gNB may guarantee that an overlapping group of PUCCH(s) and PUSCH(s) satisfy specific timeline requirements. The timeline requirements may be applied to ensure a time duration (or period) from the ending time of a scheduling DCI and a PDSCH to the starting time of the overlapping group of PUCCH(s) and PUSCH(s) is long enough for the UE to process the received DCI and the PDSCH, and to prepare the UCI and UL data for the multiplexing procedure. A first PUCCH for the HARQ-ACK in a sub-slot (or in a slot) may be overridden by a second PUCCH for the HARQ-ACK in the sub-slot (or in the slot) if DCI scheduling the second PUCCH has an ending symbol T_{proc,3} (e.g., as specified in Section 9.2.3 in TS 38.213) before the starting symbol of the first PUCCH. If the first PUCCH is overridden by the second PUCCH, the UE may transmit the second PUCCH and may not transmit the first PUCCH.

In Rel-15 and Rel-16 NR, when a PUCCH overlaps a PUSCH with the same priority, the UCI of the PUCCH may be multiplexed in the PUSCH. The UE configured with UL skipping may skip the transmission of a PUSCH dynamically scheduled by the DCI or a CG PUSCH when there is no data that may be multiplexed in a MAC PDU in the PUSCH. UL skipping may not be applicable to PUSCHs when there is a PUCCH overlapping the PUSCHs. Specifically, if the PUSCH is a PUSCH dynamically scheduled by the DCI, the MAC entity (or layer) may generate the MAC PDU for the PUSCH and deliver the MAC PDU to the PHY entity (or layer) and the UCI may be multiplexed in the PUSCH. If the PUSCH is a CG PUSCH not overlapping any PUSCH scheduled by the DCI, the MAC entity (or layer) may generate the MAC PDU for the PUSCH and deliver the MAC PDU to the PHY entity (or layer) and the UCI may be multiplexed in the PUSCH.

In Rel-16 NR, logical channel-based prioritization is introduced to determine which PUSCH (or PUCCH for SR) is transmitted when there is overlapping between the resources. Specifically, for a MAC entity configured with lch-basedPrioritization, priority of an uplink grant may be determined by the highest priority among the priorities of the logical channels with available data that are multiplexed (or may be multiplexed) in the MAC PDU. The priority of an uplink grant for which no data for logical channels is multiplexed (or may be multiplexed) in the MAC PDU may be lower than either the priority of an uplink grant for which data for any logical channel is multiplexed (or may be multiplexed) in the MAC PDU or a priority of the logical channel triggering an SR. Every uplink grant or configured uplink grant or SR PUCCH which is not de-prioritized may be checked to determine there is any overlapping uplink grant, configured uplink grant, or SR PUCCH which is not de-prioritized and has a logical channel priority higher than it. If not, the uplink grant or configured uplink grant is prioritized and the overlapping uplink grants, configured uplink grants, or SR PUCCHs are de-prioritized. When comparing an uplink grant and a configured uplink grant against the same logical channel priority, the uplink grant is prioritized and the configured uplink grant is de-prioritized. The UE may transmit the prioritized uplink grant, configured uplink grant, and SR PUCCH, and may not transmit the de-prioritized uplink grant, configured uplink grant, and SR PUCCH.

In the present disclosure, the following descriptions may be used interchangeably.

Multiplex a high priority PUCCH and a low priority PUCCH in the high priority PUCCH (or low priority PUCCH).

Multiplex a high priority PUCCH for high priority UCI(s) and low priority PUCCH for low priority UCI(s) in the high priority PUCCH (or low priority PUCCH).

Multiplex high priority UCI(s) of a high priority PUCCH and low priority UCI(s) of a low priority PUCCH in the high priority PUCCH (or low priority PUCCH).

Issues regarding UCI multiplexing are described as follows.

UCI Multiplexing of PUCCH(s) and PUSCH(s) with Different Priorities

When high priority PUCCH(s) overlap low priority PUCCH(s), there may be a need to select (or determine) a PUCCH in which high priority UCI(s) and low priority UCI(s) are multiplexed. In addition, when a high priority PUSCH overlaps low priority PUCCH(s), or when a low priority PUSCH overlaps high priority PUCCH(s), there may be a need to select a PUSCH in which high priority UCI(s) (or UL data), and low priority UCI(s) (or UL data) are multiplexed. To ensure latency and reliability of the high priority UCI(s) (or UL data), the low priority UCI(s) may be dropped. To avoid such a situation, a high priority PUCCH (or PUSCH) may be selected. Accordingly, a method for a PUCCH resource determination for the high priority PUCCH in which the high priority UCI(s) and the low priority UCI(s) are multiplexed may need to be considered. To ensure the reliability of the high priority UCI(s) (or UL data), and the low priority UCI(s) (or UL data), some conditions may be considered to determine applicability of multiplexing the low priority UCI(s) in the high priority PUCCH (or PUSCH). In addition, an (explicit) indication for the determination of whether to multiplex the low priority UCI(s) in the high priority PUCCH (or PUSCH) may be needed to avoid ambiguity of a PUCCH resource set determination (e.g., resulted from miss detection of DCI scheduling the low priority PUCCH(s)).

UCI Multiplexing of One PUCCH with One Priority and Multiple Non-Overlapping PUCCHs with Another Priority

When one PUCCH with one priority overlaps multiple non-overlapping PUCCHs (e.g., PUCCHs not overlapping each other) with another priority, there may be a need to select a PUCCH in which high priority UCI(s) and low priority UCI(s) are multiplexed. In addition, when a PUSCH with one priority overlaps multiple non-overlapping PUCCHs with another priority, how to multiplex UCIs may need to be determined.

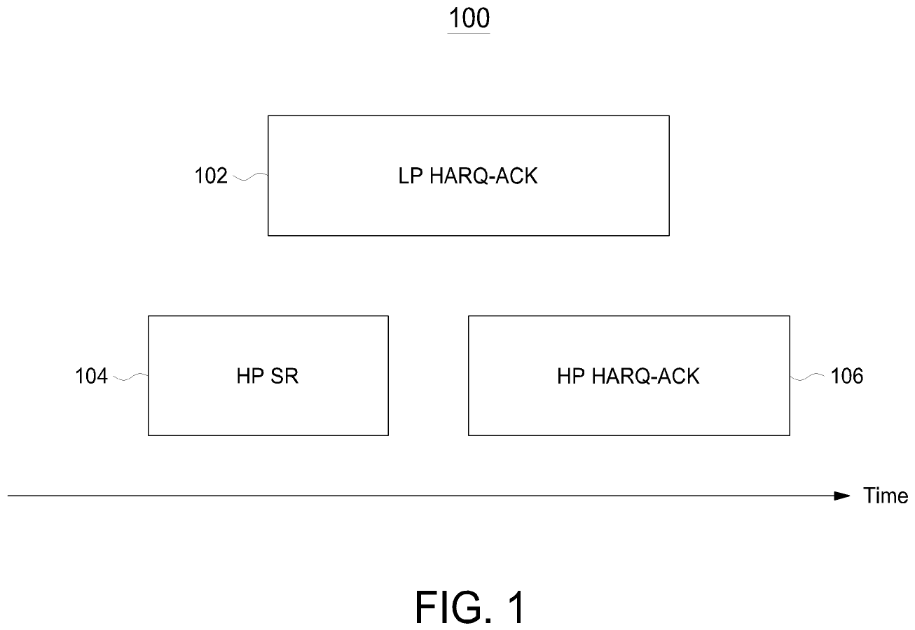

FIG. 1 is a timing diagram 100 illustrating a PUCCH with a priority overlapping multiple non-overlapping PUCCHs with another priority according to an example implementation of the present disclosure. As shown in FIG. 1, PUCCH resource 102 for (transmitting) LP HARQ-ACK overlaps PUCCH resource 104 for HP SR and PUCCH resource 106 for HP HARQ-ACK, while PUCCH resource 104 for HP SR does not overlap PUCCH resource 106 for HP HARQ-ACK. PUCCH resource 102 for LP HARQ-ACK may have a low priority. PUCCH resource 104 for HP SR and PUCCH resource 106 for HP HARQ-ACK may have a high priority.

UCI Multiplexing of PUCCH(s) and PUSCH(s) in a Group of Overlapping PUSCHs with Different Priorities

When a PUCCH with a first priority overlaps a PUSCH with the first priority, UCI of the PUCCH may be multiplexed in the PUSCH with the first priority. If the PUSCH with the first priority also overlaps a PUSCH with a second priority, the PUSCH with the second priority may be prioritized over the former PUSCH (e.g., the PUSCH with the first priority) according to the priorities of the PUSCHs. That is, the UCI multiplexed in the PUSCH may be dropped if the PUSCH is dropped. Thus, a method may be needed to avoid the UCI being dropped in a case that the PUSCH overlapping the PUCCH is prioritized by another PUSCH(s). In addition, if a high priority PUCCH overlaps a low priority PUSCH, UCI of the high priority PUCCH may be multiplexed in the low priority PUSCH. Thus, a method may be needed to avoid the UCI of the high priority PUCCH being multiplexed in the low priority PUSCH which may be prioritized by another PUSCH(s) overlapping the low priority PUSCH.

Multiplexing of High Priority HARQ-ACK (or SR) and Low Priority HARQ-ACK with a Specific Total Payload Size

When a PUCCH for high priority HARQ-ACK (or high priority SR) overlaps a PUCCH for low priority HARQ-ACK, if the total payload size of the low priority HARQ-ACK and the high priority HARQ-ACK is not more than 2 bits, or if the total payload size of the low priority HARQ-ACK and the high priority HARQ-ACK and high priority SR is not more than 2 (or 3) bits, the UCIs of the overlapping PUCCHs may be multiplexed in a PUCCH resource with PUCCH format 0 (or PUCCH format 1). In this case, how to ensure the reliability of the high priority UCI(s) (e.g., high priority HARQ-ACK, high priority SR) may need to be considered.

To deal with the above issues, implementations may be as follows.

UCI Multiplexing of PUCCH(s) and PUSCH(s) with Different Priorities

In the present disclosure, the meaning of “a first DCI or PDSCH or PUSCH or PUCCH is earlier than a second DCI or PDSCH or PUSCH or PUCCH” may refer to one or a combination of the following conditions.
The first symbol of the first DCI or PDSCH or PUSCH or PUCCH is earlier in time than the first symbol of the second DCI or PDSCH or PUSCH or PUCCH.
The last symbol of the first DCI or PDSCH or PUSCH or PUCCH is earlier in time than the last symbol of the second DCI or PDSCH or PUSCH or PUCCH.
The last symbol of the first DCI or PDSCH or PUSCH or PUCCH is earlier in time than the first symbol of the second DCI or PDSCH or PUSCH or PUCCH.

It should be noted that “a high priority PUCCH” may be a PUCCH carrying multiplexed UCI(s) determined from a UCI multiplexing procedure (e.g., as specified in Clause 9.2.5 in TS 38.213 V16.3.0) for (or performed on) a group (or plurality) of overlapping high priority PUCCHs. “A low priority PUCCH” may be a PUCCH carrying multiplexed UCI(s) determined from a UCI multiplexing procedure for a group of overlapping low priority PUCCHs.

When a high priority PUCCH for (transmitting) high priority UCI overlaps a low priority PUCCH for (transmitting) low priority UCI in the time domain, the following implementations may be used for determining whether to multiplex the high priority UCI and the low priority UCI in a PUCCH.

An indication for determination of whether to multiplex the low priority UCI and the high priority UCI in the low priority PUCCH (or the high priority PUCCH) may be included in the DCI scheduling a PUCCH (e.g., the low priority PUCCH (or the high priority PUCCH)). Specifically, if the DCI scheduling the high priority PUCCH indicates to a UE to perform UCI multiplexing (procedure) on the high priority PUCCH and the overlapping low priority PUCCH, the UE may multiplex the high priority UCI of the high priority PUCCH and the low priority UCI of the low priority PUCCH in the PUCCH (e.g., the low priority PUCCH (or the high priority PUCCH)). The indication may also indicate that the PUCCH (in which the high priority UCI and the low priority UCI is multiplexed) is selected from a PUCCH-Config (e.g., PUCCH resource configuration) associated with a high priority HARQ-ACK codebook or from a PUCCH-Config associated with a low priority HARQ-ACK codebook. The indication may also indicate from which PUCCH resource set the PUCCH is selected.

In some implementations, the DCI scheduling the low priority PUCCH may include an indication for determination of whether to multiplex the UCIs of the low priority PUCCH and the high priority PUCCH overlapping the low priority PUCCH. If the high priority PUCCH is scheduled by the DCI (e.g., the high priority PUCCH is a PUCCH for HARQ-ACK codebook transmission including at least HARQ-ACK corresponding to dynamically scheduled PDSCHs), and if the DCI scheduling the low priority PUCCH includes an indication of whether to multiplex the UCIs of the low priority PUCCH and the high priority PUCCH overlapping the low priority PUCCH, the UE may multiplex the UCIs of the low priority PUCCH and the high priority PUCCH if both indications (e.g., indication included in the DCI scheduling the low priority PUCCH and indication included in the DCI scheduling the high priority PUCCH) indicate to the UE to perform multiplexing. In some implementations, the UE may multiplex the UCIs of the low priority PUCCH and the high priority PUCCH if at least one indication indicates to the UE to perform multiplexing. In some implementations, the UE may multiplex the UCIs of the low priority PUCCH and the high priority PUCCH if the latest indication indicates to the UE to perform multiplexing. In some implementations, the UE may multiplex the UCIs of the low priority PUCCH and the high priority PUCCH if the indication included in the DCI scheduling the high priority PUCCH indicates to the UE to perform multiplexing, and when the PUCCH in which the UCIs of the low priority PUCCH and the high priority PUCCH are multiplexed is selected from the PUCCH-Config associated with the low priority HARQ-ACK codebook, and if the indication included in the DCI scheduling the low priority PUCCH indicates to the UE to perform multiplexing.

In some implementations, RRC parameters may be configured for at least one of a PUCCH resource, PUCCH resources in a PUCCH resource set, a PUCCH-Config, a PUCCH resource for the SR, a PUCCH resource for the CSI report, and a PUCCH resource for the SPS HARQ-ACK, to indicate whether to perform multiplexing the UCI(s) of the PUCCH resource(s) overlapping a PUCCH resource with a different priority. The implementations for the indications included in the DCI may be applied to the RRC parameters. For example, the indication(s) in the above implementations may be replaced by the RRC parameter(s) in case there is no scheduling DCI for the PUCCH resource(s), in case there is no indication in the DCI scheduling the PUCCH resource(s), or in case the DCI scheduling the PUCCH resource(s) is not the latest DCI scheduling the high priority PUCCH and the low priority PUCCH overlapping the high priority PUCCH. In some implementations, in case the DCI scheduling a high priority PUCCH (or a low priority PUCCH) is not the latest DCI scheduling the high priority PUCCH and the low priority PUCCH overlapping the high priority PUCCH, an RRC parameter may take precedence (or be prioritized) over the indication included in the scheduling DCI. In some implementations, an RRC parameter may indicate some PUCCH resource sets, and multiplexing the UCI of the high priority PUCCH and the low priority PUCCH overlapping the high priority PUCCH may be performed if at least one of the low priority PUCCH and the high priority PUCCH is selected from the indicated PUCCH resource sets.

In some implementations, the PUCCH in which the UCIs of the low priority PUCCH and the high priority PUCCH overlapping the low priority PUCCH are multiplexed may be selected from the PUCCH resource set based on a PRI. The RRC parameter may indicate the PUCCH resource set from which the PUCCH is selected. In some implementations, an RRC parameter may be configured for the UE to indicate whether to perform multiplexing the UCIs of the high priority PUCCH(s) and the low priority PUCCH(s) overlapping the high priority PUCCH(s). In some implementations, a PUCCH resource set may be determined from the PUCCH resource sets configured for the high priority PUCCHs based on the total payload size of the high priority UCI and a predefined (or configured) number of bits for multiplexing the low priority UCI. In other words, the PUCCH resource set may not be determined based on actual transmitted number of bits of the low priority UCI, but the PUCCH resource set may be determined based on a predefined (or configured) number of bits. In some implementations, a PUCCH resource set may be determined from the PUCCH resource sets configured for the high priority PUCCHs based on the total payload size of the high priority UCI, and a number of bits for multiplexing the low priority UCI indicated in the DCI scheduling the high priority PUCCH. The indicated number of bits or multiplexing the low priority UCI may be indicated from a list of predefined (or configured) number of bits.

In some implementations, the UE may perform multiplexing UCIs of a low priority PUCCH and a high priority PUCCH overlapping the low priority PUCCH if at least one indication in the scheduling DCIs indicates to the UE to perform multiplexing. In some implementations, the UCI of the low priority PUCCH and the UCI of the high priority PUCCH may be multiplexed in the PUCCH scheduled by a DCI including an indication indicating to the UE to perform multiplexing if (only) one of the high priority PUCCH and low priority PUCCH is scheduled by the DCI including the indication indicating to the UE to perform multiplexing. In some implementations, the UCI of the low priority PUCCH and the UCI of the high priority PUCCH may be multiplexed in a PUCCH selected from a PUCCH-Config associated with the HARQ-ACK codebook scheduled by a DCI including an indication indicating to the UE to perform multiplexing, if (only) one of the high priority PUCCH and low priority PUCCH is scheduled by the DCI including the indication indicating to the UE to perform multiplexing. The PUCCH may be selected from the PUCCH-Config based on the PRI included in the DCI. In some implementations, if both DCIs scheduling the high priority PUCCH and the low priority PUCCH include indications indicating to the UE to perform multiplexing, the UCI of the low priority PUCCH and the UCI of the high priority PUCCH may be multiplexed in the PUCCH scheduled by the later DCI. In some implementations, if both DCI scheduling the high priority PUCCH and DCI scheduling low priority PUCCH are scheduled by the DCI including indications indicating to the UE to perform multiplexing, the UCI of the low priority PUCCH and the UCI of the high priority PUCCH may be multiplexed in a PUCCH selected from a PUCCH-Config associated with the HARQ-ACK codebook scheduled by the later DCI including indications indicating to the UE to perform multiplexing. The PUCCH may be selected from the PUCCH-Config based on the PRI included in the later DCI.

In some implementations, if both DCI scheduling the high priority PUCCH and DCI scheduling the low priority PUCCH are scheduled by the DCI including indications indicating to the UE to perform multiplexing, the UCI of the low priority PUCCH and the UCI of the high priority PUCCH may be multiplexed in the high priority PUCCH. In some implementations, if both DCI scheduling the high priority PUCCH and DCI scheduling the low priority PUCCH are scheduled by the DCI including indications indicating to the UE to perform multiplexing, the UCI of the low priority PUCCH and the UCI of the high priority PUCCH may be multiplexed in a PUCCH selected from a PUCCH-Config associated with the high priority HARQ-ACK codebook. The PUCCH may be selected from the PUCCH-Config based on the PRI included in the DCI scheduling the high priority HARQ-ACK codebook.

In some implementations, multiplexing UCIs of a first PUCCH with a first priority and a second PUCCH with a second priority in a third PUCCH with the first priority (or the second priority) may be performed if at least one of the following conditions is met. It should be noted that the third PUCCH may be the same as the first PUCCH (or the second PUCCH). In some implementations, the third PUCCH may not be the same as the first PUCCH (or the second PUCCH).
DCI scheduling the first PUCCH indicates to the UE to perform multiplexing.
An RRC parameter for the first PUCCH indicates to the UE to perform multiplexing.
DCI scheduling the second PUCCH indicates to the UE to perform multiplexing.
An RRC parameter for the second PUCCH indicates to the UE to perform multiplexing.
An RRC parameter for the third PUCCH indicates that the third PUCCH may be used for the multiplexed UCIs.
The first PUCCH and the second PUCCH are overlapping in the time domain.
The third PUCCH overlaps the first PUCCH (or the second PUCCH).
The first PUCCH, the second PUCCH, and the third PUCCH and the associated DCIs and PDSCHs satisfy multiplexing timeline (constraint).
The third PUCCH is applicable for multiplexing the multiplexed UCI of the first PUCCH and the second PUCCH. For example, the PUCCH format of the third PUCCH includes the payload size of the multiplexed UCI, or the coding rate of the UCI of the first PUCCH does not exceed a first threshold and the coding rate of the UCI of the second PUCCH does not exceed a second threshold when the multiplexed UCI of the first PUCCH and the second PUCCH are multiplexed in the third PUCCH. It should be noted that the first threshold and the second threshold may be the same. In some implementations, the first threshold and the second threshold may not be the same.

In some implementations, the low priority PUCCH and the high priority PUCCH may be considered as overlapping in time if both of the PUCCH resources are included in a group of overlapping PUCCH resources.

When at least one of the high priority PUCCH for high priority UCI and the low priority PUCCH for low priority UCI overlaps a PUSCH in the time domain, determination of whether to multiplex at least one of the high priority UCI and the low priority UCI in the PUSCH may be as follows.

When a PUCCH overlaps a PUSCH, an indication for determination of whether to multiplex the UCI of the PUCCH in the PUSCH may be included in the DCI scheduling the PUCCH. In addition, an indication may be included in the DCI scheduling the PUSCH for determination of whether to multiplex the UCI of the PUCCH in the PUSCH, and the indication may be a beta offset (indicator). Whether to multiplex the UCI in the PUSCH may be determined (implicitly) according to a value of the beta offset. For example, if the beta offset for UCI with a priority has a value of 0, the UCI with the priority may not be multiplexed in the PUSCH. Otherwise, the UCI may be multiplexed in the PUSCH and the total number of resource elements used for multiplexing the UCI with priority may be calculated based on the value of the beta offset for the UCI with priority.

In some implementations, the UE may multiplex the UCI(s) with a priority of the PUCCH in the PUSCH if both indication in the DCI scheduling the PUCCH and indication in the DCI scheduling the PUSCH indicate to the UE to perform multiplexing. In some implementations, the DCI scheduling the PUCCH may not include an indication indicating to the UE to multiplex the UCI(s) of the PUCCH in the PUSCH. In this case, the UE may multiplex the UCI(s) in the PUSCH if the indication included in the DCI scheduling the PUSCH indicates to the UE to perform the multiplexing. In some implementations, the UE may multiplex the UCI(s) in the PUSCH (only) if the DCI scheduling the PUCCH is earlier than the DCI scheduling the PUSCH.

In some implementations, the RRC parameters may be configured for at least one of a PUCCH resource, PUCCH resources in a PUCCH resource set, for a PUCCH-Config, a PUCCH resource for SR, and a PUCCH resource for SPS HARQ-ACK, to indicate whether to multiplex the UCI(s) of the PUCCH resource(s) overlapping a PUSCH resource with a different priority. The implementations for the indications included in a DCI may be applied to the RRC parameters. For example, the indication(s) in the above implementations may be replaced by the RRC parameter(s) in case there is no DCI scheduling the PUCCH resource(s), or in case there is no indication in the DCI scheduling the PUCCH resource. For example, an RRC parameter may be configured for a low priority PUCCH, which indicates whether the UE may multiplex the UCI(s) of the low priority PUCCH in a high priority PUSCH overlapping the low priority PUCCH. As another example, an RRC parameter may be configured for a high priority PUSCH, which indicates whether the UE may multiplex the UCI(s) of a low priority PUCCH in the high priority PUSCH overlapping the low priority PUCCH. In some implementations, an RRC parameter may be configured for the UE to indicate whether to multiplex the UCIs of an overlapping PUCCH in a PUSCH with different priority.

In some implementations, a first PUCCH may be considered as overlapping a PUSCH if the UCI(s) of the first PUCCH is multiplexed in a second PUCCH (e.g., as described in the above implementations), and the second PUCCH overlaps the PUSCH. In this case, it may be considered that the DCI scheduling the first PUCCH does not included an indication indicating whether to multiplex the UCI(s) in a PUSCH with a different priority, or it may be considered that the first PUCCH is not scheduled by the DCI.

In some implementations, multiplexing the UCI(s) of a first PUCCH with a first priority in a PUSCH with a second priority may be performed if at least one of the following conditions is met.
DCI scheduling the first PUCCH indicates to the UE to perform multiplexing.
An RRC parameter for the first PUCCH indicates to the UE to perform multiplexing.
DCI scheduling the PUSCH indicates to the UE to perform multiplexing.
An RRC parameter for the PUSCH indicates to the UE to perform multiplexing.
The first PUCCH and the PUSCH overlap in time.
A second PUCCH with the second priority overlaps the PUSCH in time, and the first PUCCH overlaps the second PUCCH in time, and the UE receives at least one of a first indication for the UE to perform multiplexing UCI(s) of the first PUCCH in the second PUCCH and a second indication for the UE to perform multiplexing the multiplexed UCI in the second PUCCH in the PUSCH. The first indication is indicated by at least one of an RRC parameter for the first PUCCH, the DCI scheduling the first PUCCH, an RRC parameter for the second PUCCH, and the DCI scheduling the second PUCCH. The second indication is indicated by at least one of the RRC parameter for the second PUCCH and the DCI scheduling the second PUCCH.
A second PUCCH with the second priority overlaps the first PUCCH in time, and the UE receives at least one of a first indication for the UE to perform multiplexing of the second PUCCH in the first PUCCH and a second indication for the UE to perform multiplexing the UCI(s) of the second PUCCH in the PUSCH. The first indication is indicated by at least one of an RRC parameter for the first PUCCH, the DCI scheduling the first PUCCH, an RRC parameter for the second PUCCH, and the DCI scheduling the second PUCCH. The second indication is indicated by at least one of the RRC parameter for the PUSCH and the DCI scheduling the PUSCH.
The first PUCCH, the second PUCCH, and the PUSCH and the associated DCIs and PDSCHs satisfy multiplexing timeline (constraint).
The PUSCH is applicable for multiplexing the UCI(s) of the first PUCCH. For example, the coding rate of the UCI(s) does not exceed a threshold when being multiplexed in the PUSCH.

It should be noted that if high priority UCI(s) multiplexed in a high priority PUCCH (or a PUCCH) is determined not to be multiplexed in a low priority PUSCH, the low priority PUSCH may be dropped and the high priority PUCCH (or the PUCCH) in which the high priority UCI is multiplexed may be transmitted.

When a high priority PUCCH for a high priority UCI overlaps a low priority PUCCH for a low priority UCI in the time domain, determinations of which PUCCH resource set is selected and which PUCCH resource in the PUCCH resource set is selected as a PUCCH resource in which the high priority UCI and the low priority UCI are multiplexed may be as follows.

For a PUCCH included in a PUCCH-Config, an indication may be included in the DCI scheduling the PUCCH if the PUCCH-Config is the selected PUCCH-Config that includes the PUCCH(s) in which the UCIs of the high priority PUCCH and the low priority PUCCH are multiplexed. The indication may indicate from which PUCCH resource set the PUCCH is selected. From which PUCCH-Config the PUCCH is selected may be determined as described in the above implementations.

In some implementations, the indication may include 2 bits (explicitly) to indicate which PUCCH resource set of the up to 4 PUCCH resource sets is selected. In some implementations, the indication may include 1 bit to indicate whether the selected PUCCH resource set is the same as or different from a PUCCH resource set determined (only) by the UCI with the priority associated with the PUCCH-Config.

An indication may be included in the DCI(s) scheduling the PUCCH(s) included in a first PUCCH-Config if a PUCCH (in which the high priority PUCCH and the low priority PUCCH may be multiplexed) is included in a second PUCCH-Config. The indication may indicate a PUCCH resource in which the high priority PUCCH and the low priority PUCCH are multiplexed. From which PUCCH-Config the PUCCH is selected may be determined as described in the above implementations. The indication may indicate one PUCCH resource (from up to 8 PUCCH resources) from a PUCCH resource set other than a first PUCCH resource set in the second PUCCH-Config. The indication may indicate one PUCCH resource (from up to 32 PUCCH resources) from the first PUCCH resource set in the second PUCCH-Config.

In some implementations, an indication used for selecting the PUCCH from a PUCCH resource set may be included in the DCI scheduling the one of a first PUCCH-Config if the PUCCH (in which the high priority PUCCH and the low priority PUCCH may be multiplexed) is included in the first PUCCH-Config. Which PUCCH-Config and which PUCCH resource set in the PUCCH-Config may be used may be as described in the above implementations.

The UCI multiplexing of a high priority PUCCH and a low priority PUCCH overlapping the high priority PUCCH may be as follows.

When a low priority PUCCH(s) overlaps a low priority PUSCH(s), a UCI multiplexing procedure (e.g., as specified in Section 9.2.5 in TS 38.213) may first be performed on (or for) the low priority PUCCH(s) and PUSCH(s) in a slot or in sub-slot(s) configured by a first sub-slot configuration for a PUCCH-Config associated with a low priority HARQ-ACK codebook. A low priority PUCCH in the slot or in the sub-slot(s) configured by the first sub-slot configuration in the slot may be determined based on the UCI multiplexing procedure. If the low priority PUCCH overlaps a high priority PUCCH in the slot or in a sub-slot configured by a second sub-slot configuration in the slot, the UE may perform a UCI multiplexing procedure in the sub-slot configured by the second sub-slot configuration in the slot for multiplexing the UCIs of the high priority PUCCH and the low priority PUCCH. It should be noted that the high priority PUCCH in the slot or in the sub-slot configured by the second sub-slot configuration in the slot may be determined based on another UCI multiplexing procedure (e.g., performed on PUCCH(s) in the slot or in the sub-slot configured by the second sub-slot configuration in the slot).

It should be noted that when the sub-slots configured by the first sub-slot configuration overlap the sub-slot configured by the second sub-slot configuration, the UCI multiplexing procedure on the low priority PUCCH(s) and PUSCH(s) in the sub-slots configured by the first sub-slot configuration may be performed before the UCI multiplexing procedure for multiplexing the UCIs of the high priority PUCCH(s) and low priority PUCCH(s) in the sub-slot configured by the second sub-slot configuration (as described below) is performed. The first sub-slot configuration may be configured for the PUCCH-Config associated with the low priority HARQ-ACK codebook and the second sub-slot configuration may be configured for the PUCCH-Config associated with the high priority HARQ-ACK codebook.

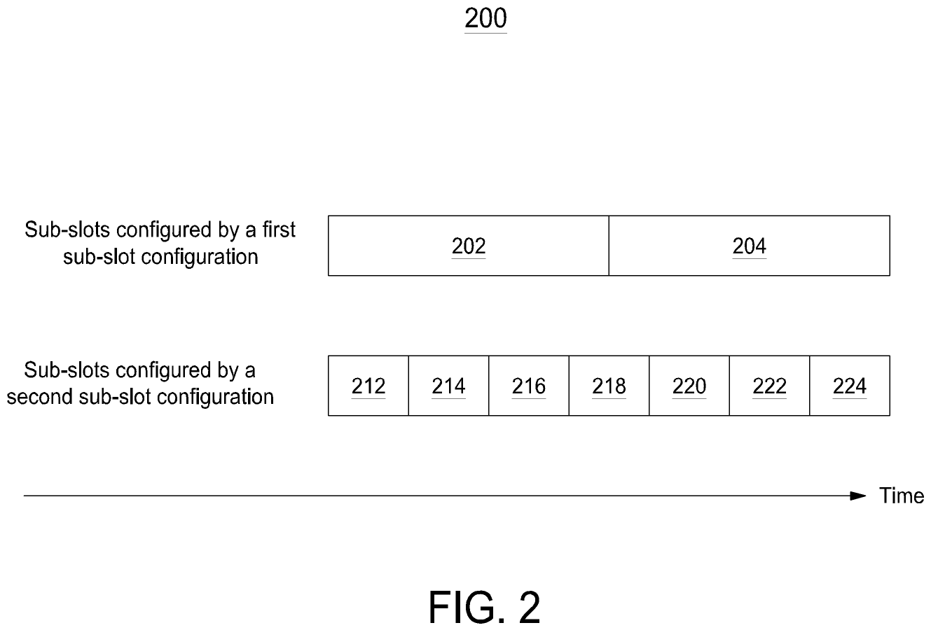

FIG. 2 is a timing diagram 200 illustrating sub-slots configured by a first sub-slot configuration and a second sub-slot configuration according to an example implementation of the present disclosure. As shown in FIG. 2, two sub-slots 202 and 204 are configured by the first sub-slot configuration, and seven sub-slots 212, 214, 216, 218, 220, and 222 are configured by the second sub-slot configuration. A sub-slot configured by the first sub-slot configuration may have 7 symbols. A sub-slot configured by the second sub-slot configuration may have 2 symbols. A length of the sub-slot configured by the second sub-slot configuration may not be longer than a length of the sub-slot configured by the first sub-slot configuration. It should be noted that the number of sub-slots configured by the first sub-slot configuration and the number of sub-slots configured by the second sub-slot configuration are not limited to what is shown and described in FIG. 2.

In some implementations, the high priority PUCCH may be a configured PUCCH (or a scheduled PUCCH) for a high priority HARQ-ACK, or a PUCCH for a high priority positive SR. In some implementations, when a PUCCH for a high priority HARQ-ACK overlaps a PUCCH for a high priority SR, the high priority PUCCH may be a PUCCH in which the high priority HARQ-ACK and the high priority SR are multiplexed.

The UCI multiplexing procedure in the sub-slot configured by the second sub-slot configuration in the slot for multiplexing the UCIs of the high priority PUCCH and the low priority PUCCH may be as follows.
The UE may determine if a high priority PUCCH overlaps a low priority PUCCH determined from the UCI multiplexing procedure on the low priority PUCCH(s) and PUSCH(s). If the high priority PUCCH overlaps the low priority PUCCH, the UE may proceed to the following steps. Otherwise, the UE may proceed to perform a UCI multiplexing procedure on the PUCCH(s) (configured) in a PUCCH-Config associated with a high priority HARQ-ACK codebook and the PUCCH(s) for a high priority SR in the sub-slot configured by the second sub-slot configuration (e.g., as specified in Section 9.2.5 in TS 38.213). It should be noted that the low priority PUCCH may be a PUCCH carrying the UCI(s) which is/are not multiplexed in a PUCCH (or PUSCH) or is/are not dropped after the UCI multiplexing procedure in another (e.g., previous) sub-slot configured by the second sub-slot configuration is performed.
The UE may construct (or obtain) a first set of PUCCH resources (e.g., in the sub-slot configured by the second sub-slot configuration). The first set of PUCCH resources may include the PUCCH resources on which the UCI multiplexing procedure is performed. For example, the first set of PUCCH resources may include the low priority PUCCH, PUCCH resource(s) in the PUCCH-Config associated with the high priority, and PUCCH resource(s) for SR configured as high priority with starting symbols within the sub-slot configured by the second sub-slot configuration. A PUCCH resource for a negative SR transmission that does not overlap a PUCCH resource for a HARQ-ACK may not be included in the first set of PUCCH resources. It should be noted that the first set of PUCCH resources may be referred to as a set Q.
The UE may select a reference PUCCH resource from the first set of PUCCH resources. A PUCCH resource with the earliest first symbol is selected as the reference PUCCH resource. If more than one PUCCH resource has the earliest first symbol, the PUCCH resource with the longest duration and the earliest first symbol is selected as the reference PUCCH resource.
The UE may determine a second group of (overlapping) PUCCH resources. The UE may determine a resulting PUCCH resource and the corresponding multiplexed UCIs (multiplexed in the resulting PUCCH resource) from the second group of PUCCH resources. The second group of PUCCH resources may include the reference PUCCH resource and the PUCCH resource(s) in the first set of PUCCH resources which overlaps the reference PUCCH resource. Determination of the multiplexed UCIs and the resulting PUCCH resource may be as described in the above implementations.
If UCI(s) of a third PUCCH resource(s) in the second group of PUCCH resources is multiplexed in the resulting PUCCH resource, the UE may exclude the third PUCCH resource(s) from the first set of PUCCH resources, except for the resulting PUCCH resource. The UE may return to the above steps if there are overlapping PUCCH resources in the first set of PUCCH resources in the sub-slot configured by the second sub-slot configuration. Otherwise, the UCI multiplexing procedure in the sub-slot configured by the second sub-slot configuration may be ended. The UE may prepare to transmit the multiplexed UCI in the resulting PUCCH resource. The UE may proceed to perform a UCI multiplexing procedure in another (e.g., next) sub-slot configured by the second sub-slot configuration in the slot.

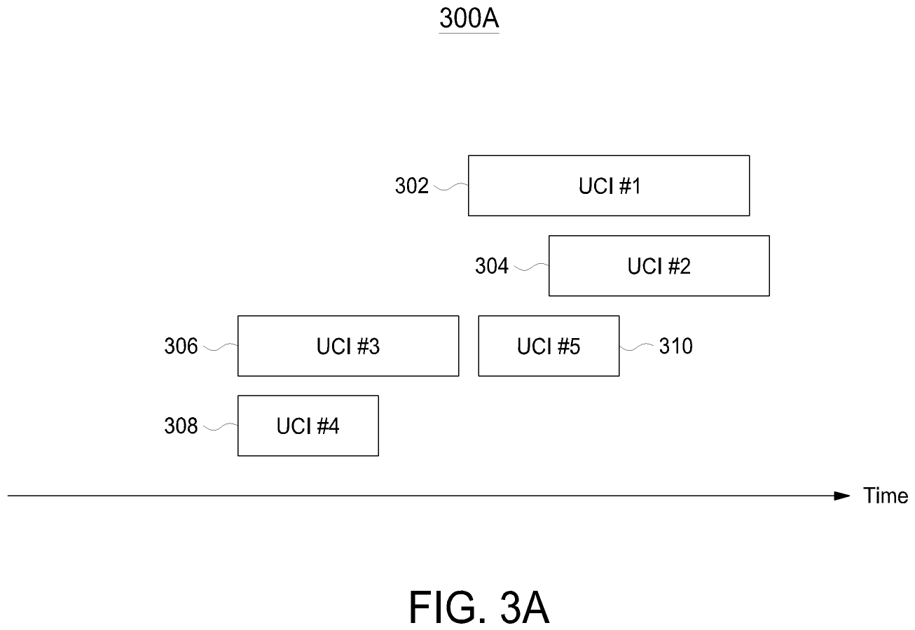

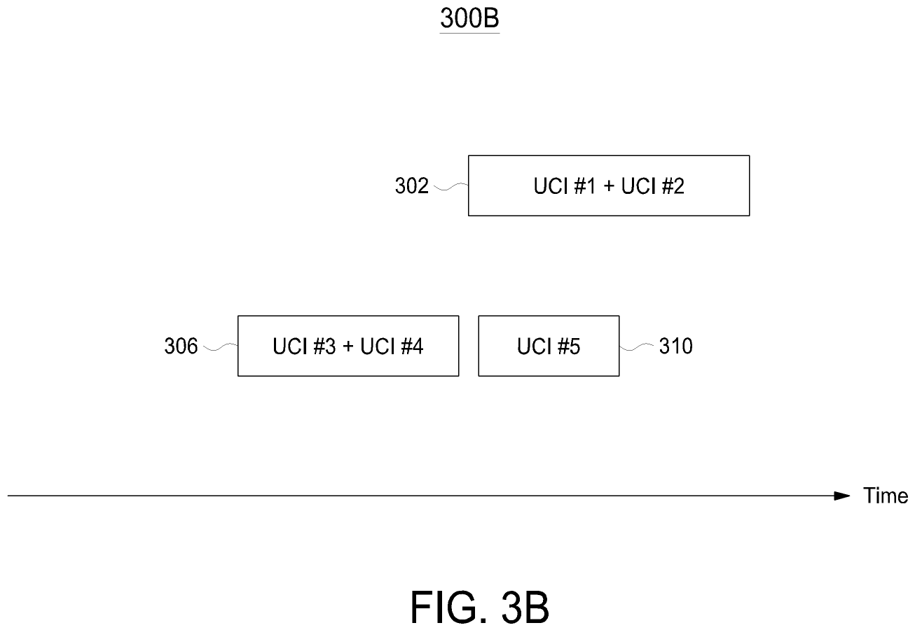

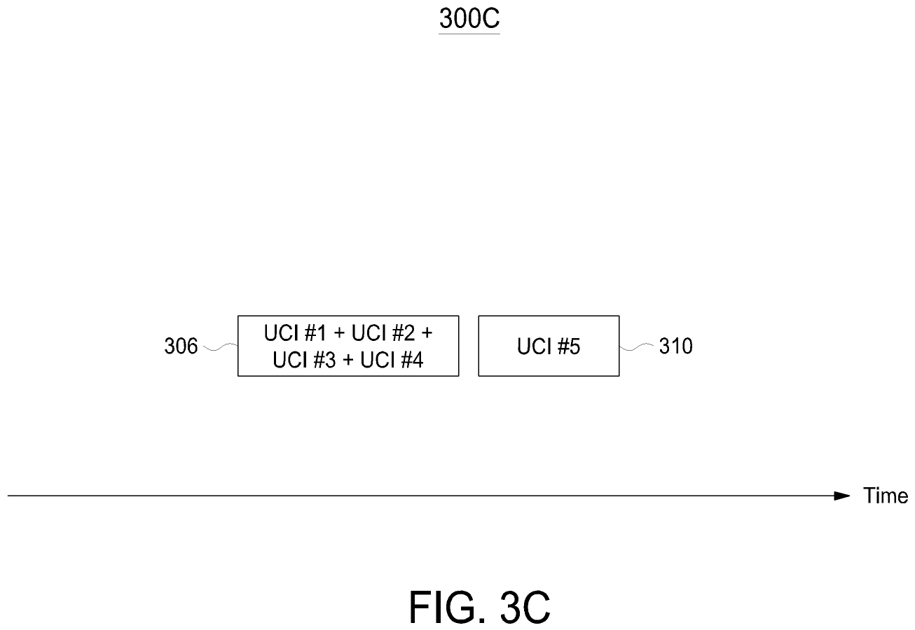

FIG. 3A is a schematic diagram 300A illustrating a UCI multiplexing procedure for multiplexing UCIs of a high priority PUCCH and a low priority PUCCH, according to an example implementation of the present disclosure. As shown in FIG. 3A, PUCCH resource 302 for (LP) UCI #1 overlaps PUCCH resource 304 for (LP) UCI #2. PUCCH resource 306 for (HP) UCI #3 overlaps PUCCH resource 308 for (HP) UCI #4, but does not overlap PUCCH resource 310 for (HP) UCI #5. The UE may perform a UCI multiplexing procedure on a first set of PUCCH resources (e.g., PUCCH resource 302 for UCI #1 and PUCCH resource 304 for UCI #2). The UE may perform a UCI multiplexing procedure on a second set of PUCCH resources (e.g., PUCCH resource 306 for UCI #3, PUCCH resource 308 for UCI #4, and PUCCH resource 310 for UCI #5). Accordingly, the UE may multiplex UCI #1 and UCI #2 in PUCCH resource 302. The UE may multiplex UCI #3 and UCI #4 in PUCCH resource 306.

FIG. 3B is a schematic diagram 300B illustrating a UCI multiplexing procedure for multiplexing UCIs of a high priority PUCCH and a low priority PUCCH, according to an example implementation of the present disclosure. As shown in FIG. 3B, PUCCH resource 302 for the multiplexed UCIs (e.g., UCI #1 and UCI #2) overlaps PUCCH resource 306 for the multiplexed UCIs (e.g., UCI #3 and UCI #4) and PUCCH resource 310 for the UCI (e.g., UCI #5). The UE may determine to multiplex the multiplexed UCIs of PUCCH resource 302 in a PUCCH resource overlapping PUCCH resource 302 (e.g., PUCCH resource 306, or PUCCH resource 310) instead of dropping the multiplexed UCIs of PUCCH resource 302. The UE may perform a UCI multiplexing procedure on a third set of PUCCH resources (e.g., PUCCH resource 302 for UCI #1 and UCI #2, PUCCH resource 306 for UCI #3 and UCI #4, and PUCCH resource 310 for UCI #5). Accordingly, the UE may multiplex UCI #1, UCI #2, UCI #3, and UCI #4 in PUCCH resource 306.

FIG. 3C is a schematic diagram 300C illustrating a UCI multiplexing procedure for multiplexing UCIs of a high priority PUCCH and a low priority PUCCH, according to an example implementation of the present disclosure. As shown in FIG. 3C, PUCCH resource 306 is for the multiplexed UCIs (e.g., UCI #1, UCI #2, UCI #3, and UCI #4), and PUCCH resource 310 is for the UCI (e.g., UCI #5). The UE may transmit the multiplexed UCIs (e.g., UCI #1, UCI #2, UCI #3 and UCI #4) using PUCCH resource 306, and transmit the UCI (e.g., UCI #5) using PUCCH resource 310.

In the above step, the UE may first perform a UCI multiplexing procedure for PUCCH(s) (configured) in a PUCCH-Config associated with a high priority HARQ-ACK codebook and PUCCH(s) for high priority SR in the sub-slot configured by the second sub-slot configuration (e.g., as specified in Section 9.2.5 in TS 38.213). In some implementations, the UE may first perform a UCI multiplexing procedure on PUCCH(s) (configured) in a PUCCH-Config associated with a high priority HARQ-ACK codebook and PUCCH(s) for high priority SR in the sub-slot configured by the second sub-slot configuration if there is a high priority PUSCH overlapping a high priority PUCCH in the sub-slot configured by the second sub-slot configuration. In this case, the multiplexed UCI in the resulting PUCCH is multiplexed in the high priority PUSCH, and the remaining high priority PUCCHs in the sub-slot configured by the second sub-slot configuration not associated with the multiplexed UCI may be included in the above step. In some implementations, the high priority PUCCH and the low priority PUCCH may be considered as overlapping if at least one of the DCI scheduling the high priority PUCCH and the low priority PUCCH indicates to the UE to perform the multiplexing. In some implementations, the low priority PUCCH overlapping at least one of the semi-static DL symbols and the SSB symbols may not be considered as overlapping the high priority PUCCH. In some implementations, the high priority PUCCH overlapping at least one of the semi-static DL symbols and the SSB symbols may be considered as overlapping the low priority PUCCH. In some implementations, the UE may perform the UCI multiplexing procedure on PUCCH(s) (configured) in the PUCCH-Config associated with the high priority HARQ-ACK codebook and PUCCH(s) for high priority SR in the sub-slot configured by the second sub-slot configuration (e.g., as specified in Section 9.2.5 in TS 38.213) if there is no indication of performing the UCI multiplexing of the high priority PUCCH and the low priority PUCCH (as described in the above step). In some implementations, the UE may determine to perform the UCI multiplexing procedure on PUCCH(s) (configured) in the PUCCH-Config associated with the high priority HARQ-ACK codebook and PUCCH(s) for high priority SR in the sub-slot configured by the second sub-slot configuration (e.g., as specified in Section 9.2.5 in TS 38.213) if the high priority PUCCH is scheduled by the DCI and a UCI multiplexing timeline (constraint) between the DCI and the low priority PUCCH is not satisfied. It should be noted that after the UE performs the UCI multiplexing procedure on the PUCCH(s) (configured) in the PUCCH-Config associated with the high priority HARQ-ACK codebook and the PUCCH(s) for high priority SR in the sub-slot configured by the second sub-slot configuration (e.g., as specified in Section 9.2.5 in TS 38.213), the low priority PUCCH overlapping the resulting PUCCH may be dropped. In some implementations, the UE may not expect to receive the DCI scheduling a second low priority PUCCH later than the DCI scheduling the high priority PUCCH when the UE determines to perform the UCI multiplexing procedure for multiplexing the UCIs of the high priority PUCCH and a first low priority PUCCH with a corresponding DCI, and the first low priority PUCCH may be overridden by the second low priority PUCCH. In some implementations, the above step may be performed after the UE attempts to decode a set of DCI candidates that may be used for scheduling the low priority PUCCHs with ending symbols that are T_{proc,3} before the starting symbol of a low priority PUCCH scheduled by the DCI if there is no high priority PUCCH scheduled by the DCI which is detected before the UE attempts to decode the set of DCI candidates.

In the above step, the low priority PUCCH with starting symbol not within the sub-slot configured by the second sub-slot configuration may be included in the first set of PUCCH resources if the UCI of the low priority PUCCH is not multiplexed in a PUCCH or PUSCH or is not dropped after a UCI multiplexing procedure in previous sub-slots configured by the sub-slot of the second sub-slot configuration is performed.

In the above step, the reference PUCCH resource may be selected (only) from the PUCCH resource(s) (configured) in the PUCCH-Config associated with the high priority HARQ-ACK codebook and the PUCCH resource(s) for high priority SR. In some implementations, the reference PUCCH resource may be the low priority PUCCH if (only) the low priority PUCCH is scheduled by the DCI.

In the above step, when the second group of PUCCH resources includes PUCCH resource(s) for HARQ-ACK, a PUCCH resource set may be determined based on the payload size of the HARQ-ACK and other types of UCI (e.g., SR) of the second group of PUCCH resources (e.g., based on the above described implementations), and the resulting PUCCH resource in the PUCCH resource set in which the UCIs of the second group of PUCCH resources are multiplexed may be selected based on the PRI in the DCI scheduling a PUCCH for a high priority HARQ-ACK codebook. If the second group of PUCCH resources include low priority PUCCH resource(s), the payload size of the types of low priority UCI applicable for multiplexing in a high priority PUCCH and the UCI of high priority PUCCH resources in the second group of PUCCH resources may be used to determine the PUCCH resource set. If the PUCCH resource indicated by the PRI in the determined PUCCH resource set is not included in the second group of PUCCH resources or if the PUCCH resource indicated by the PRI results in a coding rate of the high priority UCI (or low priority UCI) exceeding certain thresholds, a compression or dropping parts of the low priority HARQ-ACK codebook may be performed. After dropping or compression of the low priority HARQ-ACK codebook, the total payload size for determination of the PUCCH resource set may be updated according to the dropping or compression of the low priority HARQ-ACK codebook. If the PUCCH resource indicated by the PRI in the newly determined PUCCH resource set is still not included in the second group of PUCCH resources or if the PUCCH resource still results in a coding rate of the high priority UCI (or low priority UCI) exceeding certain thresholds, the UE may further compress or drop the whole low priority HARQ-ACK codebook. In some implementations, the UE may determine the PUCCH resources indicated by the PRI in the PUCCH resource sets that are included in the second group of PUCCH resources before determining the PUCCH resource set based on the total payload size, and if all PUCCH resource sets with PUCCH resources indicated by the PRI included in the second group of PUCCH resources have corresponding maximum payload sizes not applicable for multiplexing the total payload, the UE may drop or compress the low priority HARQ-ACK codebook based on the maximum payload sizes corresponding to the PUCCH resource sets with the PUCCH resources indicated by the PRI included in the second group of PUCCH resources. In some implementations, the UE may select a PUCCH resource indicated by the PRI from the PUCCH resource sets with corresponding minimum payload sizes larger than the total payload if no other PUCCH resources applicable for multiplexing the UCIs is included in the second group of PUCCH resources. In some implementations, more than one PUCCH may be determined from the above step. For example, if there are a PUCCH for a high priority HARQ-ACK codebook and a PUCCH for a low priority HARQ-ACK codebook (and other low priority UCIs) in the second group of PUCCH resources, and the PUCCH for the high priority HARQ-ACK codebook and the PUCCH for the low priority HARQ-ACK codebook (and other low priority UCIs) are not overlapping each other. In this case, the high priority SR(s) of the PUCCH(s) for the high priority SR in the second group of PUCCH resources may be multiplexed in the PUCCH for the high priority HARQ-ACK codebook, and the PUCCH for the low priority HARQ-ACK codebook (and other low priority UCIs) may be transmitted separately. In some implementations, if the high priority PUCCH for the multiplexed high priority HARQ-ACK codebook and the high priority SR(s) overlaps the low priority PUCCH for the low priority HARQ-ACK codebook (and other low priority UCIs), a PUCCH resource in which the high priority HARQ-ACK codebook and the high priority SR(s), and/or the low priority HARQ-ACK codebook are multiplexed is determined from the second group of PUCCH resources. Whether the low priority HARQ-ACK codebook is multiplexed in the PUCCH resource or not may be determined based on the above described implementations. In some implementations, the high priority SR(s) of the PUCCH resource(s) for the high priority SR in the second group of PUCCH resources may be multiplexed in the PUCCH for the high priority HARQ-ACK codebook if the PUCCH resource(s) for the high priority SR overlaps the PUCCH for the high priority HARQ-ACK codebook, and the high priority SR(s) of the PUCCH resource(s) for the high priority SR in the second group of PUCCH resources may be multiplexed in the PUCCH for the low priority HARQ-ACK codebook if the PUCCH resource(s) for the high priority SR does not overlap the PUCCH for the high priority HARQ-ACK codebook (e.g., based on the above described implementations).

In some implementations, a first high priority PUCCH for high priority HARQ-ACK codebook in a slot (or a sub-slot) may be overridden by a DCI later than the DCI scheduling the first high priority PUCCH. In other words, a corresponding DCI of a second high priority PUCCH for high priority HARQ-ACK codebook in the slot (or the sub-slot) may replace the first high priority PUCCH and the corresponding DCI. It should be noted that the high priority HARQ-ACK codebook size in the second high priority PUCCH may be larger than the high priority HARQ-ACK codebook size in the first high priority PUCCH, e.g., when the high priority HARQ-ACK codebook is a Type 2 HARQ-ACK codebook. The UCI multiplexing procedure in the sub-slot configured by the second sub-slot configuration in the slot for multiplexing the UCIs of the first high priority PUCCH and other high priority PUCCH(s) and the low priority PUCCH may be performed by the UE in response to receiving the DCI scheduling the first high priority PUCCH. When the UE receives the DCI scheduling the second high priority PUCCH, it may be needed to determined whether to perform another UCI multiplexing procedure in the sub-slot configured by the second sub-slot configuration in the slot for multiplexing the UCIs of the second high priority PUCCH and other high priority PUCCH(s) and the low priority PUCCH.

In some implementations, the UE may perform another UCI multiplexing procedure in response to receiving the DCI scheduling the second high priority PUCCH. During this UCI multiplexing procedure, the UE may expect that the decision on whether to multiplex, compress, or drop the low priority HARQ-ACK codebook of the low priority PUCCH in a high priority PUCCH remains the same as the decision made during the previous UCI multiplexing procedure performed based on the first high priority PUCCH and the corresponding DCI.

In some implementations, if the low priority HARQ-ACK of the low priority PUCCH is determined to be multiplexed in a third high priority PUCCH after the UCI multiplexing procedure is performed based on the first high priority PUCCH and the corresponding DCI, the UE may not expect that the same decision will be made when the UCI multiplexing procedure is performed based on the second high priority PUCCH and its corresponding DCI. In other words, the low priority HARQ-ACK of the low priority PUCCH may not be multiplexed in a fourth high priority PUCCH when the UCI multiplexing procedure is performed based on the second high priority PUCCH and the corresponding DCI. It should be noted that the third high priority PUCCH may be the same as the fourth high priority PUCCH. In some implementations, the third high priority PUCCH may not be the same as the fourth high priority PUCCH. In some implementations, the UE may expect that the third high priority PUCCH and the fourth high priority PUCCH are included in the same PUCCH resource set. In some implementations, the UE may not (need to) perform another UCI multiplexing procedure in response to receiving the DCI scheduling the second high priority PUCCH if the first high priority PUCCH is the same as the second high priority PUCCH, and the UE may expect that the third high priority PUCCH is the same as the fourth high priority PUCCH. In some implementations, the UE may perform another UCI multiplexing procedure in response to receiving DCI scheduling the second high priority PUCCH if the third high priority PUCCH is overlapping at least one of semi-static DL symbols and SSB symbols.

In some implementations, the UE may expect that a UCI multiplexing timeline (constraint) is satisfied between the first high priority PUCCH, the second high priority PUCCH, the corresponding DCIs and PDSCHs of the first high priority PUCCH and the second high priority PUCCH. In some implementations, the UE may expect that the UCI multiplexing timeline (constraint) is satisfied between the second high priority PUCCH and the corresponding DCI if the second high priority PUCCH is the same as the first high priority PUCCH. In some implementations, the UE may not expect that the UCI multiplexing timeline (constraint) is satisfied between the second high priority PUCCH and the corresponding DCI if the second high priority PUCCH is the same as the first high priority PUCCH.

In some implementations, after a UCI multiplexing procedure for multiplexing the UCIs of a high priority PUCCH without a corresponding DCI and a low priority PUCCH is performed (e.g., as described above), the UE may expect to perform another UCI multiplexing procedure for multiplexing the UCIs of the high priority PUCCH and other high priority PUCCH(s) and the low priority PUCCH in response to receiving the DCI scheduling the other high priority PUCCH(s), and the UCI of the low priority PUCCH may be dropped after the other UCI multiplexing procedure is performed.

In some implementations, when performing the UCI multiplexing procedure (e.g., as specified in Section 9.2.5 in TS 38.213) on overlapping low priority PUCCHs in a slot or in sub-slots configured by a first sub-slot configuration for a PUCCH-Config associated with a low priority HARQ-ACK codebook, PUCCH resources for the high priority SR may be included in the first set of PUCCH resources on which the UCI multiplexing procedure is performed if a PUCCH resource for the low priority HARQ-ACK codebook scheduled by the DCI is indicated to be used for multiplexing the PUCCH resources for the high priority SR, as described in the above implementation.

### Multiplexing of a Resulting PUCCH in a PUSCH

After the UCI multiplexing procedure, as described above, is completed, if the resulting PUCCH overlaps a PUSCH, a part, or all, of the multiplexed UCI in the resulting PUCCH may be multiplexed in the PUSCH (e.g., based on the above described implementations). In some implementations, if the UCI of the first high priority PUCCH and the UCI of the low priority PUCCH are multiplexed in the third high priority PUCCH, and if the multiplexed UCIs in the third high priority PUCCH is further multiplexed in a PUSCH, the UE may not expect the first high priority PUCCH to be overridden by a second high priority PUCCH scheduled by a DCI that is later than the DCI scheduling the first high priority PUCCH and the DCI scheduling the PUSCH.

UCI Multiplexing of One PUCCH with a Priority and Multiple Non-Overlapping PUCCHs with Another Priority

It should be noted that “a high priority PUCCH” may be a PUCCH carrying multiplexed UCI(s) determined from a UCI multiplexing procedure (e.g., as specified in Clause 9.2.5 in TS 38.213 V16.3.0), for (or performed on) a group (or plurality) of overlapping high priority PUCCHs. “A low priority PUCCH” may be a PUCCH carrying multiplexed UCI(s) determined from a UCI multiplexing procedure, for a group of overlapping low priority PUCCHs.

Scenarios of one PUCCH with a priority overlapping multiple non-overlapping PUCCHs with another priority may be as follows.

A PUCCH for low priority HARQ-ACK may overlap (at least) two non-overlapping high priority PUCCHs.

Scenario: A PUCCH for low priority HARQ-ACK overlaps (at least) two non-overlapping PUCCHs for high priority HARQ-ACKs in different sub-slots.

Scenario: A PUCCH for low priority HARQ-ACK overlaps (at least) one PUCCH for high priority HARQ-ACK and (at least) one PUCCH for high priority SR, and the two high priority PUCCHs are not overlapping each other. This scenario may be detailed as follows.
the PUCCH for high priority HARQ-ACK and the PUCCH for high priority SR are in the same sub-slot.
the PUCCH for high priority HARQ-ACK and the PUCCH for high priority SR are in different sub-slots.

Scenario: A PUCCH for low priority HARQ-ACK overlaps two non-overlapping PUCCHs for high priority SRs.

A PUCCH for high priority HARQ-ACK may overlap (at least) two of non-overlapping high priority PUCCHs and low priority PUCCHs.

Scenario: A PUCCH for high priority HARQ-ACK overlaps (at least) two non-overlapping PUCCHs for low priority HARQ-ACKs in different sub-slots.

Scenario: A PUCCH for high priority HARQ-ACK overlaps (at least) one PUCCH for low priority HARQ-ACK and (at least) one PUCCH for high priority SR (or low priority SR), and the PUCCH for low priority HARQ-ACK and the PUCCH for high priority SR (or low priority SR) are not overlapping each other. This scenario may be detailed as follows.
the PUCCH for low priority HARQ-ACK and the PUCCH for high priority SR (or low priority SR) are in the same sub-slot.
the PUCCH for low priority HARQ-ACK and the PUCCH for high priority SR (or low priority SR) are in different sub-slots.

It should be noted that the following implementations may not only be applicable to the above scenarios, but may also be applicable to other scenarios not described above. For example, the following implementations may be used for the above scenarios if the UE has the capability of supporting the above scenarios (e.g., reported by the UE), and the UE may use the implementations if configured by a gNB.

A first sub-slot configuration may be configured for a PUCCH-Config associated with a low priority HARQ-ACK codebook. A second sub-slot configuration may be configured for a PUCCH-Config associated with a high priority HARQ-ACK codebook.

The UCI multiplexing procedure described above may be used for the above scenarios (e.g., the PUCCH for low priority HARQ-ACK overlaps two non-overlapping PUCCHs for high priority HARQ-ACKs in different sub-slots). The UE may perform the UCI multiplexing procedure on a first PUCCH for high priority HARQ-ACK and a first PUCCH for low priority HARQ-ACK in a first sub-slot configured by a second sub-slot configuration in response to receiving DCI scheduling the first PUCCH for high priority HARQ-ACK in the first sub-slot configured by the second sub-slot configuration. The UE may not expect that a second PUCCH for high priority HARQ-ACK scheduled in a second sub-slot configured by the second sub-slot configuration overlaps the first PUCCH for low priority HARQ-ACK, if the low priority HARQ-ACK is not multiplexed in the first PUCCH for high priority HARQ-ACK in the first sub-slot configured by the second sub-slot configuration, or if the first low priority HARQ-ACK is not dropped after the UCI multiplexing procedure is performed in the first sub-slot configured by the second sub-slot configuration.

In some implementations, when the low priority HARQ-ACK is determined to be dropped after the UCI multiplexing procedure is performed in the first sub-slot configured by the second sub-slot configuration, the low priority HARQ-ACK may be included in the first set of PUCCH resources (as described above) when the UCI multiplexing procedure is performed in the second sub-slot configured by the second sub-slot configuration. In this case, the UE may not expect that a PUCCH for high priority HARQ-ACK scheduled in the second sub-slot configured by the second sub-slot configuration overlaps the PUCCH for low priority HARQ-ACK, if the UCI(s) of the low priority PUCCH is not multiplexed in the PUCCH for high priority HARQ-ACK scheduled in the second sub-slot, or the UCI(s) of the low priority PUCCH is not dropped after the UCI multiplexing procedure is performed in the second sub-slot configured by the second sub-slot configuration.

In some implementations, when UCIs of a second PUCCH for high priority HARQ-ACK in a first sub-slot configured by the second sub-slot configuration and a PUCCH for low priority HARQ-ACK are determined to be multiplexed in a first PUCCH for low priority HARQ-ACK after the UCI multiplexing procedure is performed in the first sub-slot configured by the second sub-slot configuration, the UE may expect that UCIs of a fourth PUCCH for high priority HARQ-ACK in the second sub-slot configured by the second sub-slot configuration and the first PUCCH for low priority HARQ-ACK (with multiplexed high priority HARQ-ACK) are determined to be multiplexed in a third PUCCH for low priority HARQ-ACK after the UCI multiplexing procedure is performed in the second sub-slot configured by the second sub-slot configuration, if the fourth PUCCH for high priority HARQ-ACK is scheduled to overlap the first PUCCH for low priority HARQ-ACK (with multiplexed high priority HARQ-ACK). The first PUCCH for low priority HARQ-ACK and the third PUCCH for low priority HARQ-ACK may be the same. In some implementations, the first PUCCH for low priority HARQ-ACK and the third PUCCH for low priority HARQ-ACK may not be the same.

In some implementations, when UCIs of a second PUCCH for high priority HARQ-ACK in a first sub-slot configured by the second sub-slot configuration and a PUCCH for low priority HARQ-ACK are determined to be multiplexed in a first PUCCH for low priority HARQ-ACK after the UCI multiplexing procedure is performed in the first sub-slot configured by the second sub-slot configuration, the UE may drop the UCI(s) of the first PUCCH and transmit the UCI(s) of the second PUCCH and a third PUCCH for high priority HARQ-ACK, if the third PUCCH is scheduled in the second sub-slot configured by the second sub-slot configuration and overlaps the first PUCCH, and if the third PUCCH is determined to be transmitted after the UCI multiplexing procedure is performed in the second sub-slot configured by the second sub-slot configuration. It should be noted that the UCI multiplexing timeline (constraint) may be satisfied between the PUCCH for low priority HARQ-ACK, the second PUCCH, the third PUCCH and the corresponding DCIs and PDSCHs.

In some implementations, when a first PUCCH for low priority HARQ-ACK overlaps a second PUCCH for high priority SPS HARQ-ACK in a first sub-slot configured by the second sub-slot configuration, the UE may not expect to be scheduled with a third PUCCH for high priority HARQ-ACK in a second sub-slot configured by the second sub-slot configuration, and the third PUCCH overlapping the first PUCCH for low priority HARQ-ACK, if UCIs of the first PUCCH and the third PUCCH are determined to be multiplexed in a fourth PUCCH for low priority HARQ-ACK after the UCI multiplexing procedure is performed in the second sub-slot configured by the second sub-slot configuration, and if the fourth PUCCH overlaps the second PUCCH. It should be noted that the first sub-slot may be later than the second sub-slot, and the first PUCCH may be the same as the fourth PUCCH. In some implementations, the first PUCCH may not be the same as the fourth PUCCH. In some implementations, the UE may not expect scheduling of the third PUCCH as described above with additional condition as follows. When the fourth PUCCH overlaps the second PUCCH, the high priority SPS HARQ-ACK may not be multiplexed in a fifth PUCCH for low priority HARQ-ACK after the UCI multiplexing procedure is performed in the first sub-slot configured by the second sub-slot configuration, where the fifth PUCCH may be the same as the fourth PUCCH. In some implementations, the fifth PUCCH may not be the same as the fourth PUCCH.

The above implementations may be used for the above scenarios (e.g., the PUCCH for high priority HARQ-ACK overlaps (at least) two non-overlapping PUCCHs for low priority HARQ-ACKs in different sub-slots), with low priority and high priority reversed. In other words, the PUCCH for high priority HARQ-ACK is in the first sub-slot configuration, and the UCI multiplexing procedure (e.g., as specified in Sec 9.2.5 in TS 38.213) may be performed firstly for the high priority PUCCHs as described above.

The UCI multiplexing procedure described above may be used for the above scenarios (e.g., the PUCCH for low priority HARQ-ACK overlaps (at least) one PUCCH for high priority HARQ-ACK and (at least) one PUCCH for high priority SR, the two high priority PUCCHs are not overlapping each other, and the PUCCH for high priority HARQ-ACK and the PUCCH for high priority SR are in the same sub-slot). When the high priority HARQ-ACK and the high priority SR are determined to be multiplexed in a same PUCCH, the high priority HARQ-ACK and the high priority SR may be concatenated and jointly encoded. It should be noted that the high priority SR may be the triggered positive SR in a slot (or in a sub-slot), and the number of bits for the SR may be determined by the number of high priority SR PUCCH resources in (a group of) overlapping PUCCH resources. Specifically, if the number of high priority SR PUCCH resources in the overlapping PUCCH resources is X, ┌log₂(X+1)┐ bits may be used to indicate the SR. The 0 value may be used to indicate there is no SR triggered in the X SR resources.

The UCI multiplexing procedure described above may be used for the above scenarios (e.g., the PUCCH for high priority HARQ-ACK and the PUCCH for high priority SR are in different sub-slots). When a high priority SR in a first sub-slot configured by a second sub-slot configuration is determined to be multiplexed in a first PUCCH for low priority HARQ-ACK after the UCI multiplexing procedure is performed in the first sub-slot configured by the second sub-slot configuration, the UE may be scheduled with a second PUCCH for high priority HARQ-ACK in a second sub-slot configured by the second sub-slot configuration which overlaps the first PUCCH for low priority HARQ-ACK if the first PUCCH and the second PUCCH is determined to be multiplexed in a third PUCCH for high priority HARQ-ACK (or a fourth PUCCH for low priority HARQ-ACK) after the UCI multiplexing procedure is performed in the second sub-slot configured by the second sub-slot configuration. The third PUCCH may be the same as the second PUCCH. The fourth PUCCH may be the same as the first PUCCH. In some implementations, the third PUCCH may not be the same as the second PUCCH. The fourth PUCCH may not be the same as the first PUCCH.

In some implementations, the high priority SR may be multiplexed in the third PUCCH if the low priority HARQ-ACK is dropped after the UCI multiplexing procedure is performed in the second sub-slot configured by the second sub-slot configuration. When a high priority HARQ-ACK and a high priority SR are determined to be multiplexed in a same PUCCH, the high priority HARQ-ACK and the high priority SR may be concatenated and jointly encoded. When the high priority SR is multiplexed in the third PUCCH for high priority HARQ-ACK (or in the fourth PUCCH for low priority HARQ-ACK), and if there are other high priority SR resources in the second sub-slot configured by the second sub-slot configuration and determined to be multiplexed in the third PUCCH for high priority HARQ-ACK (or the fourth PUCCH for low priority HARQ-ACK), the SR bits of the high priority SR in the first sub-slot and the SR bits of the high priority SR in the second sub-slot may be concatenated and jointly encoded. Specifically, if the number of high priority SR PUCCH resources in the overlapping PUCCH resources in the first sub-slot is X, ┌log₂(X+1)┐ bits may be used to indicate the SR in the first sub-slot. If the number of high priority SR PUCCH resources in the overlapping PUCCH resources in the second sub-slot is Y, ┌log₂(Y+1)┐ bits may be used to indicate the SR in the second sub-slot.

In some implementations, when a high priority SR in a first sub-slot is multiplexed in a low priority PUCCH, the SR bits of the high priority SR in the second sub-slot may not be multiplexed in the third PUCCH (or in the fourth PUCCH), and the PUCCH resources for high priority SR in the second sub-slot may be considered as not valid if the PUCCH resources for high priority SR overlap the low priority PUCCH, or the triggered high priority SR in the PUCCH resources for high priority SR overlapping the low priority PUCCH is dropped. In some implementations, when a PUCCH for high priority HARQ-ACK in the first sub-slot is multiplexed in the low priority PUCCH, the triggered high priority SR in the PUCCH resources for high priority SR in the second sub-slot overlapping the low priority PUCCH may be dropped.

The above implementations may be used for the above scenarios (e.g., the PUCCH for high priority HARQ-ACK overlaps (at least) one PUCCH for low priority HARQ-ACK and (at least) one PUCCH for high priority SR (or low priority SR), the PUCCH for low priority HARQ-ACK and the PUCCH for high priority SR (or low priority SR) are not overlapping each other, and the PUCCH for low priority HARQ-ACK and the PUCCH for high priority SR (or low priority SR) are in the same sub-slot), with low priority and high priority reversed. In other words, the PUCCH for high priority HARQ-ACK is in the first sub-slot configuration, and the UCI multiplexing procedure (e.g., as specified in Sec 9.2.5 in TS 38.213) may be performed firstly for the high priority PUCCHs as described above.

The UCI multiplexing procedure described above may be used for the above scenarios (e.g., the PUCCH for low priority HARQ-ACK overlaps two non-overlapping PUCCHs for high priority SRs). When there are PUCCHs for high priority SRs in the first sub-slot and in the second sub-slot overlapping a low priority PUCCH (e.g., a PUCCH for low priority HARQ-ACK), if the number of high priority SR (PUCCH resources) in the group of overlapping PUCCHs in the first sub-slot and in the second sub-slot are X and Y, ┌log₂(X+1)┐ and ┌log₂(Y+1)┐ bits may be used to indicate the SR in the first sub-slot and in the second sub-slot, respectively.

In some implementations, when a high priority SR in a first sub-slot is multiplexed in a low priority PUCCH, the SR bits of the high priority SR in the second sub-slot may not be multiplexed in the low priority PUCCH, and the PUCCH resources for high priority SR in the second sub-slot may be considered as not valid if the PUCCH resources for high priority SR overlap the low priority PUCCH, or the triggered high priority SR in the PUCCH resources for high priority SR overlapping the low priority PUCCH is dropped. In some implementations, the UCI multiplexing procedure for the first sub-slot and the UCI multiplexing procedure for the second sub-slot may be performed together since no high priority HARQ-ACK is scheduled in the first sub-slot (or in the second sub-slot), the low priority PUCCH may be used as a reference PUCCH resource in the UCI multiplexing procedure, and PUCCH resources for high priority SR in the first sub-slot and in the second sub-slot overlapping the low priority PUCCH may be included when constructing the second group of PUCCH resources. Accordingly, the high priority SR in the first sub-slot and the high priority SR in the second sub-slot may be multiplexed in a low priority PUCCH after the UCI multiplexing procedure is performed, and the SR bits has ┌log₂(Z+1)┐ number of bits, where Z may be the number of high priority SR resources in the first sub-slot and in the second sub-slot included in the overlapping PUCCH resources.

UCI Multiplexing of PUCCH(s) and PUSCH(s) in a Group of Overlapping PUSCHs with Different Priorities

It should be noted that “a high priority PUCCH” may be a PUCCH carrying multiplexed UCI(s) determined from a UCI multiplexing procedure (e.g., as specified in Clause 9.2.5 in TS 38.213 V16.3.0), for (or performed on) a plurality (or group) of overlapping high priority PUCCHs. “A low priority PUCCH” may be a PUCCH carrying multiplexed UCI(s) determined from a UCI multiplexing procedure (e.g., as specified in Clause 9.2.5 in TS 38.213 V16.3.0), for (or performed on) a plurality (or group) of overlapping low priority PUCCHs.

Scenarios of PUCCH(s) overlapping PUSCH(s) in a group of overlapping PUSCHs with different priorities may be as follows.

Scenario: A low priority PUCCH overlaps a first low priority DG PUSCH (or CG PUSCH), and the first low priority DG PUSCH (or CG PUSCH) overlaps a second low priority (or high priority) CG PUSCH. This scenario may be detailed as follows.
the low priority PUCCH is earlier than the second low priority (or high priority) CG PUSCH.

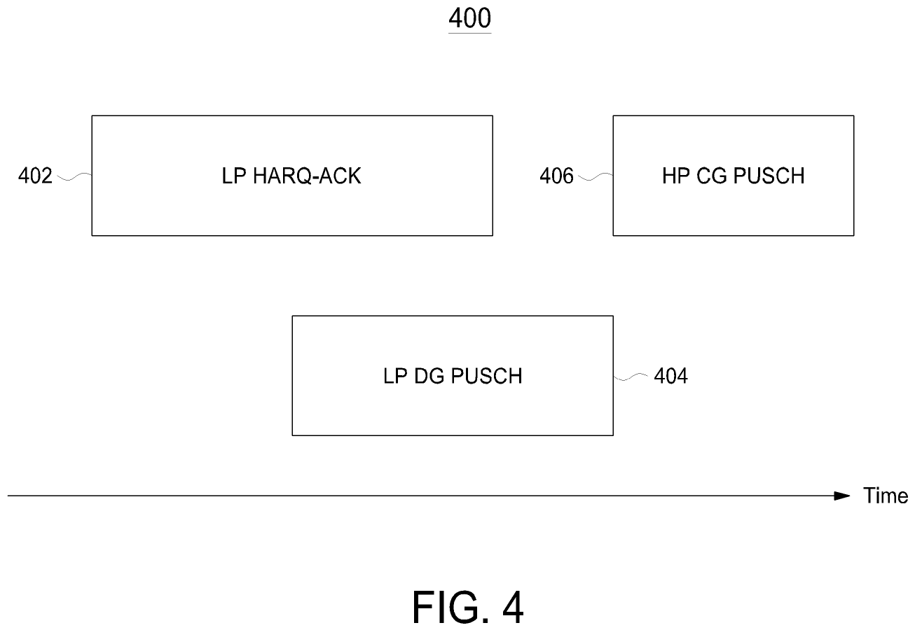

FIG. 4 is a timing diagram 400 illustrating a low priority PUCCH overlapping a low priority DG PUSCH, where the low priority DG PUSCH overlaps a high priority CG PUSCH later than the low priority PUCCH, according to an example implementation of the present disclosure. As shown in FIG. 4, PUCCH resource 402 for LP HARQ-ACK overlaps LP DG PUSCH resource 404, and LP DG PUSCH resource 404 overlaps HP CG PUSCH resource 406 later than PUCCH resource 402 for LP HARQ-ACK.
the low priority PUCCH is later than the second low priority (or high priority) CG PUSCH.

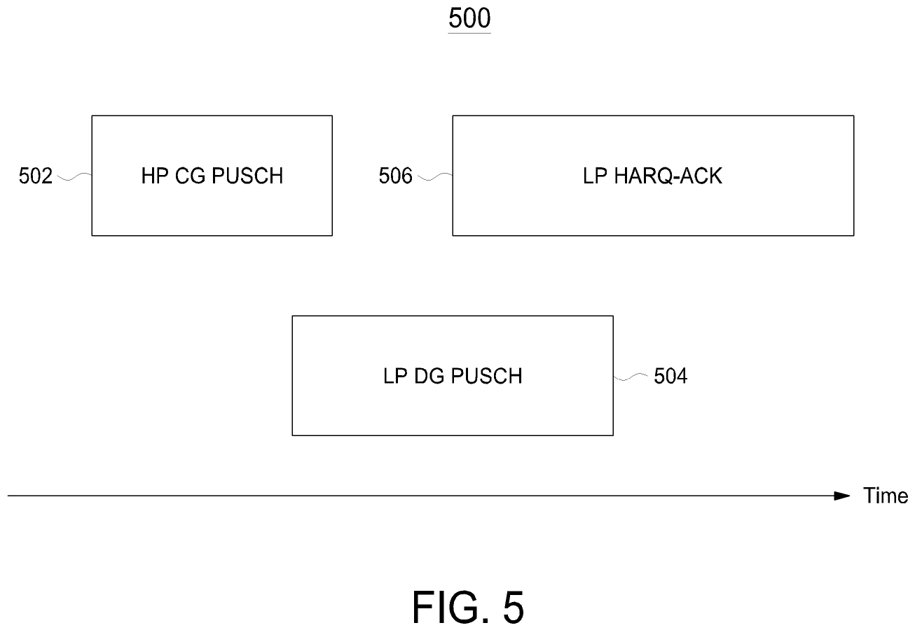

FIG. 5 is a timing diagram 500 illustrating a low priority PUCCH overlapping a low priority DG PUSCH, where the low priority DG PUSCH overlaps a high priority CG PUSCH earlier than the low priority PUCCH, according to an example implementation of the present disclosure. As shown in FIG. 5, PUCCH resource 506 for LP HARQ-ACK overlaps LP DG PUSCH resource 504, and LP DG PUSCH resource 504 overlaps HP CG PUSCH resource 502 earlier than PUCCH resource 506 for LP HARQ-ACK.

Scenario: A high priority PUCCH overlaps a first low priority DG PUSCH (or CG PUSCH), and the first low priority DG PUSCH (or CG PUSCH) overlaps a second low priority (or high priority) CG PUSCH. This scenario may be detailed as follows.
the high priority PUCCH is earlier than the second low priority (or high priority) CG PUSCH.

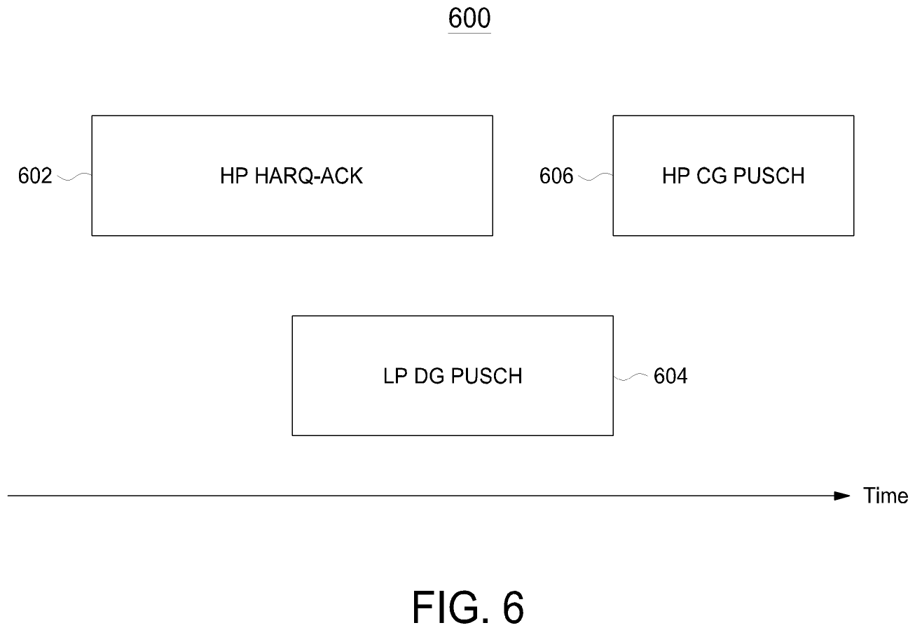

FIG. 6 is a timing diagram 600 illustrating a high priority PUCCH overlapping a low priority DG PUSCH, where the low priority DG PUSCH overlaps a high priority CG PUSCH later than the low priority PUCCH, according to an example implementation of the present disclosure. As shown in FIG. 6, PUCCH resource 602 for HP HARQ-ACK overlaps LP DG PUSCH resource 604, and LP DG PUSCH resource 604 overlaps HP CG PUSCH resource 606 later than PUCCH resource 602 for HP HARQ-ACK.
the high priority PUCCH is later than the second low priority (or high priority) CG PUSCH.

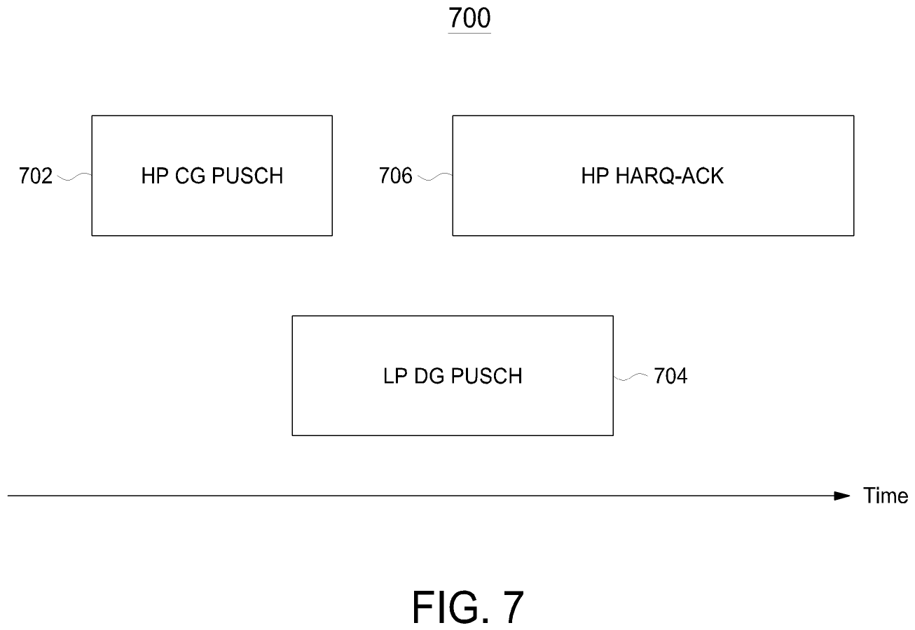

FIG. 7 is a timing diagram 700 illustrating a high priority PUCCH overlapping a low priority DG PUSCH, where the low priority DG PUSCH overlaps a high priority CG PUSCH earlier than the low priority PUCCH, according to an example implementation of the present disclosure. As shown in FIG. 7, PUCCH resource 706 for HP HARQ-ACK overlaps LP DG PUSCH resource 704, and LP DG PUSCH resource 704 overlaps HP CG PUSCH resource 702 earlier than PUCCH resource 706 for HP HARQ-ACK.

Scenario: A high priority PUCCH overlaps a first high priority CG PUSCH, a low priority PUCCH overlaps a second low priority DG PUSCH, the first high priority CG PUSCH overlaps the second low priority DG PUSCH, and the high priority PUCCH does not overlap the low priority PUCCH. This scenario may be detailed as follows.
the high priority PUCCH and the high priority CG PUSCH are earlier than the low priority PUCCH and the second low priority DG PUSCH.

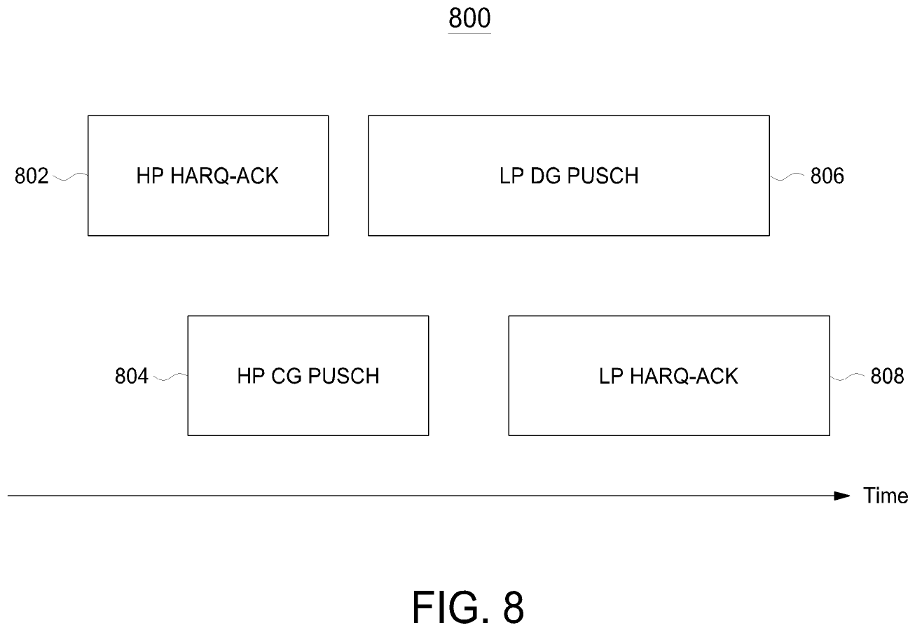

FIG. 8 is a timing diagram 800 illustrating a high priority PUCCH overlapping a high priority CG PUSCH, a low priority PUCCH overlapping a low priority DG PUSCH, where the high priority CG PUSCH overlaps the low priority DG PUSCH later than the high priority PUCCH, and the high priority PUCCH does not overlap the low priority PUCCH later than the high priority CG PUSCH, according to an example implementation of the present disclosure. As shown in FIG. 8, PUCCH resource 802 for HP HARQ-ACK overlaps HP CG PUSCH resource 804, PUCCH resource 808 for LP HARQ-ACK overlaps LP DG PUSCH resource 806, HP CG PUSCH resource 804 overlaps LP DG PUSCH resource 806 later than PUCCH resource 802 for HP HARQ-ACK, and PUCCH resource 802 for HP HARQ-ACK does not overlap PUCCH resource 808 for LP HARQ-ACK later than HP CG PUSCH resource 804.
the high priority PUCCH and the high priority CG PUSCH are later than the low priority PUCCH and the second low priority DG PUSCH.

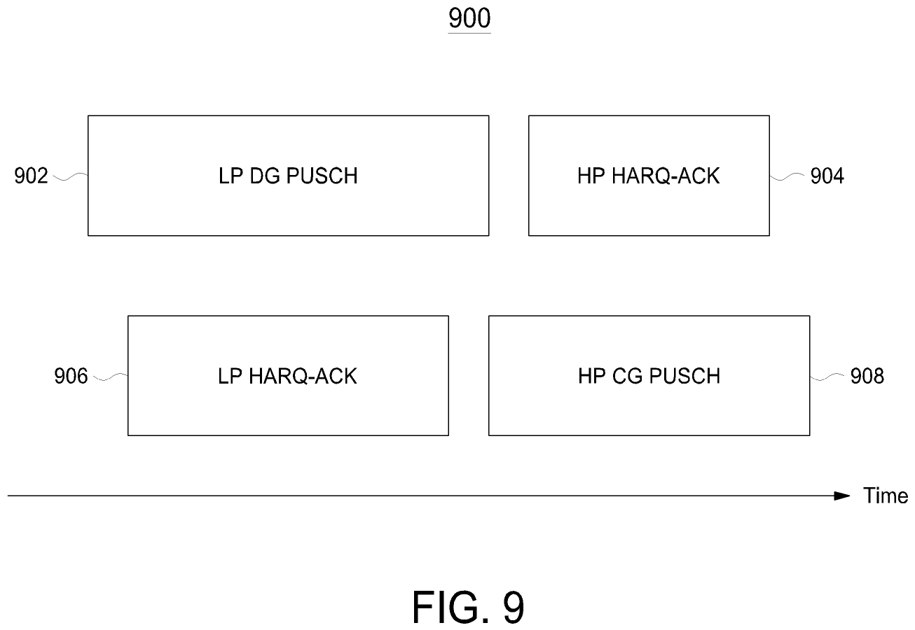

FIG. 9 is a timing diagram 900 illustrating a high priority PUCCH overlapping a high priority CG PUSCH, a low priority PUCCH overlapping a low priority DG PUSCH, where the high priority CG PUSCH overlaps the low priority DG PUSCH earlier than the high priority PUCCH, and the high priority PUCCH does not overlap the low priority PUCCH earlier than the high priority CG PUSCH, according to an example implementation of the present disclosure. As shown in FIG. 9, PUCCH resource 902 for HP HARQ-ACK overlaps HP CG PUSCH resource 904, PUCCH resource 908 for LP HARQ-ACK overlaps LP DG PUSCH resource 906, HP CG PUSCH resource 904 overlaps LP DG PUSCH resource 806 earlier than PUCCH resource 902 for HP HARQ-ACK, and PUCCH resource 902 for HP HARQ-ACK does not overlap PUCCH resource 908 for LP HARQ-ACK earlier than HP CG PUSCH resource 904.

Scenario: A high priority PUCCH overlaps a high priority CG PUSCH and the high priority CG PUSCH overlaps a low priority DG PUSCH. This scenario may be detailed as follows.
the low priority DG PUSCH does not overlap the high priority PUCCH.

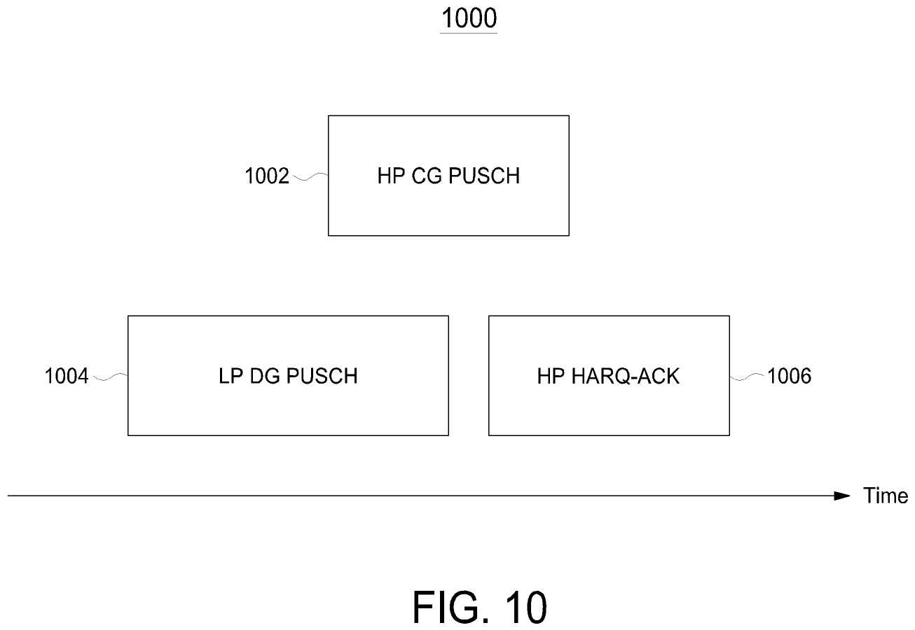

FIG. 10 is a timing diagram 1000 illustrating a high priority PUCCH overlapping a high priority CG PUSCH, where the high priority CG PUSCH overlaps a low priority DG PUSCH that does not overlap the high priority PUCCH, according to an example implementation of the present disclosure. As shown in FIG. 10, PUCCH resource 1006 for HP HARQ-ACK overlaps HP CG PUSCH resource 1002, and HP CG PUSCH resource 1002 overlaps LP DG PUSCH resource 1004 not overlapping PUCCH resource 1006 for HP HARQ-ACK.
the low priority DG PUSCH overlaps the high priority PUCCH.

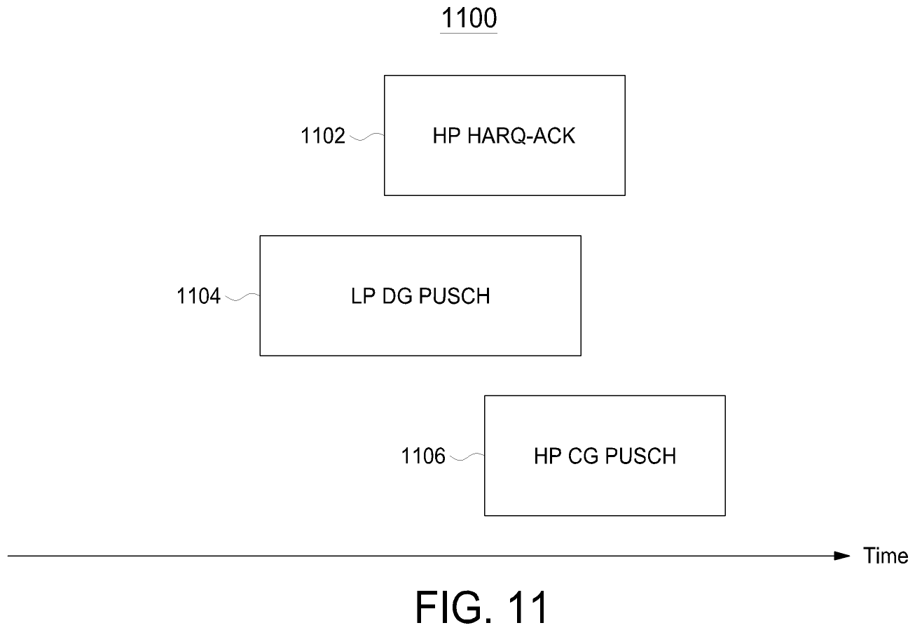

FIG. 11 is a timing diagram 1100 illustrating a high priority PUCCH overlapping a high priority CG PUSCH, where the high priority CG PUSCH overlaps a low priority DG PUSCH that overlaps the high priority PUCCH, according to an example implementation of the present disclosure. As shown in FIG. 11, PUCCH resource 1102 for HP HARQ-ACK overlaps HP CG PUSCH resource 1106, and HP CG PUSCH resource 1106 overlaps LP DG PUSCH resource 1104 overlapping PUCCH resource 1102 for HP HARQ-ACK.

Scenario: a low priority DG PUSCH overlaps a high priority HARQ-ACK and a high priority SR, and the high priority HARQ-ACK does not overlap the high priority SR.

Scenario: a high priority SR overlaps a high priority HARQ-ACK and a low priority DG PUSCH, and the high priority HARQ-ACK does not overlap the low priority DG PUSCH.

The following implementations may be used to reduce blind decodes for a gNB to detect UCI for the above scenarios. Logical channel based prioritization and UL skipping may be assumed to be configured for (an MAC entity of) a UE.

For a PUSCH overlapping a PUCCH, the MAC entity (of the UE) may check to determine whether a UL grant associated with the PUSCH is prioritized over other uplink grants associated with other PUSCHs overlapping the PUSCH, based on logical channel prioritization with a logical channel priority associated with the UL grant. The logical channel priority associated with the UL grant may be determined based on at least one of the following factors:
Physical layer priority of the PUSCH
Physical layer priority of the PUCCH
Logical channel priorities of logical channels from which data may be multiplexed in an MAC PDU in the PUSCH
Whether there is an explicit indication in DCI scheduling the PUCCH (or in DCI scheduling the PUSCH) indicating that the PUCCH is multiplexed in the PUSCH
Whether UCI of the PUCCH is determined to be multiplexed in the PUSCH
Whether the PUSCH is applicable for multiplexing the PUCCH
Whether the PUSCH is a DG PUSCH (or a CG PUSCH)
Whether there is data that may be multiplexed in the MAC PDU in the PUSCH
Types of the UCI of the PUCCH

For a PUCCH overlapping one or more PUSCHs, UCI of the PUCCH may be multiplexed in a PUSCH of the one or more PUSCHs determined from logical channel prioritization, if there is data that may be multiplexed in the PUSCH, and condition(s) for multiplexing UCI in the PUSCH is met. Otherwise, the UCI may be transmitted in the PUCCH, or the UCI may be dropped if the PUCCH is with low priority and the PUSCH is with high priority. In some implementations, the UCI of the PUCCH may be multiplexed in a PUSCH of the one or more PUSCHs determined from logical channel prioritization, and a MAC PDU with padding bits may be generated for the PUSCH when there is no data that may be multiplexed in the PUSCH.

In some implementations, for a PUSCH dynamically scheduled by the DCI overlapping a PUCCH with a same physical layer priority, the logical channel priority of the uplink grant associated with the PUSCH may be considered as higher than one of the following:
the priority of a second uplink grant for which data for any logical channels is multiplexed or may be multiplexed in a MAC PDU that may be transmitted in a DG PUSCH (or a CG PUSCH) associated with the second uplink grant
the priority of the logical channel triggering an SR

In some implementations, for a low priority PUSCH dynamically scheduled by the DCI overlapping a low priority PUCCH, the logical channel priority of the uplink grant associated with the PUSCH may be considered as the lowest logical channel priority that is higher than the following:
the priority of a second uplink grant for which data for any logical channels is multiplexed or may be multiplexed in a MAC PDU that may be transmitted in a low priority DG PUSCH (or a low priority CG PUSCH) associated with the second uplink grant
the priority of the logical channel triggering a low priority SR

In some implementations, for a PUSCH with a physical layer priority dynamically scheduled by the DCI overlapping a PUCCH that may be multiplexed in the PUSCH, the logical channel priority of the uplink grant associated with the PUSCH may be considered as the highest logical channel priority of the following:
the logical channel priority of a second uplink grant for which data for any logical channels is multiplexed or may be multiplexed in a MAC PDU that may be transmitted in a DG PUSCH (or a CG PUSCH) with the physical layer priority associated with the second uplink grant
the priority of the logical channel triggering a SR

In some implementations, for a PUSCH overlapping a PUCCH with a different physical layer priority, when the PUCCH is determined to be multiplexed in the PUSCH (e.g., based on the above described implementations), the logical channel priority of the uplink grant associated with the PUSCH may be considered as higher than one of the following:
the priority of a second uplink grant for which data for any logical channels is multiplexed or may be multiplexed in a MAC PDU that may be transmitted in a PUSCH associated with the second uplink grant
the priority of the logical channel triggering an SR

In some implementations, for a PUSCH overlapping a PUCCH, when the overlapping PUCCH is a high priority PUCCH or when the PUCCH is (explicitly) indicated to be multiplexed in the PUSCH (as described in the above implementations), the logical channel priority of the uplink grant associated with the PUSCH may be considered as higher than one of the following:
the priority of a second uplink grant for which data for any logical channels is multiplexed or may be multiplexed in a MAC PDU that may be transmitted in a PUSCH associated with the second uplink grant
the priority of the logical channel triggering an SR

In some implementations, for a PUSCH overlapping a PUCCH, the logical channel priority of the uplink grant associated with the PUSCH may be considered as the lowest logical channel priority of the logical channels from which data may be multiplexed in a MAC PDU that may be transmitted in the PUSCH, when there is no data that may be multiplexed in the MAC PDU that may be transmitted in the PUSCH.

In some implementations, for a PUSCH overlapping a PUCCH, the logical channel priority of the uplink grant associated with the PUSCH may be considered as the highest logical channel priority of the logical channels from which data may be multiplexed in a MAC PDU that may be transmitted in the PUSCH.

In some implementations, for a PUSCH overlapping a PUCCH, the logical channel priority of the uplink grant associated with the PUSCH may be considered as the lowest logical channel priority of the logical channels from which data may be multiplexed in a MAC PDU that may be transmitted in the PUSCH, when there is no data that may be multiplexed in the MAC PDU that may be transmitted in the PUSCH, and when the PUCCH is determined to be multiplexed in the PUSCH (e.g., based on the above described implementations) if the PUSCH and the PUCCH are with different priorities.

In some implementations, for a PUSCH overlapping a PUCCH, the logical channel priority of the uplink grant associated with the PUSCH may be considered as the highest logical channel priority of the logical channels from which data may be multiplexed in a MAC PDU that may be transmitted in the PUSCH, and when the PUCCH is determined to be multiplexed in the PUSCH (e.g., based on the above described implementations) if the PUSCH and the PUCCH are with different physical layer priorities.

In some implementations, for a high priority PUSCH overlapping a high priority PUCCH, the logical channel priority of the uplink grant associated with the PUSCH may be considered as the lowest logical channel priority which is higher than the following:
the highest logical channel priority of a second uplink grant for which data for any logical channels is multiplexed or may be multiplexed in a MAC PDU that may be transmitted in a low priority PUSCH associated with the second uplink grant
the priority of the logical channel triggering a low priority SR

In some implementations, for a CG PUSCH overlapping a PUCCH that may be multiplexed in the CG PUSCH, the logical channel priority of the uplink grant associated with the CG PUSCH may be considered as the highest logical channel priority of the logical channels from which data may be multiplexed in a MAC PDU that may be transmitted in the high priority CG PUSCH associated with the uplink grant.

In some implementations, for a high priority CG PUSCH overlapping a PUCCH that may be multiplexed in the CG PUSCH, the logical channel priority of the uplink grant associated with the CG PUSCH may be considered as:
the highest logical channel priority of the logical channels from which data may be multiplexed in a MAC PDU that may be transmitted in the high priority CG PUSCH associated with the uplink grant
the lowest logical channel priority that is higher than the priority of a second uplink grant for which data for any logical channels is multiplexed or may be multiplexed in a MAC PDU that may be transmitted in a low priority DG PUSCH (or a low priority CG PUSCH) associated with the second uplink grant and higher than the priority of the logical channel triggering a low priority SR.

In some implementations, for a CG PUSCH overlapping a PUCCH that may be multiplexed in the CG PUSCH, the logical channel priority of the uplink grant associated with the CG PUSCH may be considered as the highest logical channel priority of the logical channels from which there is data to be multiplexed in a MAC PDU that may be transmitted in the high priority CG PUSCH associated with the uplink grant, or the logical channel priority of the uplink grant associated with the CG PUSCH may be considered as the lowest logical channel priority of the logical channels from which data may be multiplexed in the MAC PDU that may be transmitted in the high priority CG PUSCH associated with the uplink grant when there is no data to be multiplexed in the MAC PDU from the logical channels.

In some implementations, for a high priority CG PUSCH overlapping a PUCCH that may be multiplexed in the CG PUSCH, the logical channel priority of the uplink grant associated with the CG PUSCH may be considered as the highest logical channel priority of the following two logical channel priorities:
the highest logical channel priority of the logical channels from which there is data to be multiplexed in a MAC PDU that may be transmitted in the high priority CG PUSCH associated with the uplink grant, or the logical channel priority of the uplink grant associated with the CG PUSCH may be considered as the lowest logical channel priority of the logical channels from which data may be multiplexed in the MAC PDU that may be transmitted in the high priority CG PUSCH associated with the uplink grant when there is no data to be multiplexed in the MAC PDU from the logical channels
the lowest logical channel priority that is higher than the priority of a second uplink grant for which data for any logical channels is multiplexed or may be multiplexed in a MAC PDU that may be transmitted in a low priority DG PUSCH (or a low priority CG PUSCH) associated with the second uplink grant and higher than the priority of the logical channel triggering a low priority SR.

The above implementations may be applicable for CG PUSCHs configured by CG configurations configured with a specific RRC parameter or applicable for CG PUSCHs activated by activation DCIs including an indication.

In some implementations, for a PUSCH overlapping a PUCCH, the logical channel priority of the uplink grant associated with the PUSCH may be considered as a configured (or a predefined) priority when the PUCCH is determined to be multiplexed in the PUSCH (e.g., based on the described above implementations). The configured (or predefined) priority may be based on the physical layer priority of the UCI and/or type of the UCI of the PUCCH. For example, the configured priority may be 15 for an uplink grant associated with a PUSCH if low priority HARQ-ACK is determined to be multiplexed in the PUSCH. In some implementations, the configured priority may be 13 for an uplink grant associated with a PUSCH if high priority HARQ-ACK is determined to be multiplexed in the PUSCH. In some implementations, the configured priority may be based on whether the PUSCH is dynamically scheduled by the DCI or a configured PUSCH. For example, the configured priority may be 14 for an uplink grant associated with a DG PUSCH if low priority HARQ-ACK is determined to be multiplexed in the DG PUSCH. The configured priority may be 15 for an uplink grant associated with a CG PUSCH if low priority HARQ-ACK is determined to be multiplexed in the CG PUSCH.

In some implementations, for a PUSCH overlapping a PUCCH, the logical channel priority of the uplink grant associated with the PUSCH may be considered as a configured (or a predefined) priority when the PUCCH is determined to be multiplexed in the PUSCH (e.g., based on the above described implementations). The configured (or predefined) priority may be based on the priority of the physical layer priority of the PUSCH and based on whether the PUSCH is dynamically scheduled by the DCI or a configured PUSCH. For example, the configured priority for an uplink grant associated with a high priority DG PUSCH may be 0, the configured priority for an uplink grant associated with a high priority CG PUSCH may be 1, the configured priority for an uplink grant associated with a low priority DG PUSCH may be 8, and the configured priority for an uplink grant associated with a low priority CG PUSCH may be 9.

In some implementations, for a PUSCH overlapping a PUCCH, the logical channel priority of the uplink grant associated with the PUSCH may be considered as a configured (or a predefined) priority when the PUSCH is applicable for multiplexing the PUCCH, and when there is no data that may be multiplexed in a MAC PDU that may be transmitted in the PUSCH. The configured (or predefined) priority may be based on the priority of the physical layer priority of the PUSCH. For example, the configured priority for an uplink grant associated with a high priority PUSCH may be 4, and the configured priority for an uplink grant associated with a low priority PUSCH may be 12. In some implementations, whether a PUSCH is applicable for multiplexing a PUCCH may be configured by an RRC parameter. For example, the RRC parameter may be configured in configuredGrantConfig. In some implementations, a PUSCH dynamically scheduled by the DCI may always be applicable for multiplexing a PUCCH with the same physical layer priority. In some implementations, a configured (or predefined) threshold may be used for determination of whether a PUSCH is applicable for multiplexing a PUCCH. For example, if the logical channel priorities of the logical channels from which data may be multiplexed in a MAC PDU that may be transmitted in the PUSCH are higher than the threshold, the PUSCH may not be applicable for multiplexing the PUCCH. If the logical channel priorities of the logical channels from which data may be multiplexed in a MAC PDU that may be transmitted in the PUSCH are not higher than the threshold, the PUSCH may be applicable for multiplexing the PUCCH. Different thresholds may be configured for PUCCHs with different physical layer priorities. In some implementations, the configured (or predefined) priority may be the same as the threshold.

In some implementations, the configured (or predefined) priority may be applied when there is no data that may be multiplexed in the MAC PDU in the PUSCH.

In some implementations, the logical channel priority of an uplink grant associated with the PUSCH may be the higher priority of the following:
the logical channel priority of the logical channels from which there is data that is multiplexed or may be multiplexed in a MAC PDU that may be transmitted in the PUSCH
the logical channel priority determined based on the above described implementations

It should be noted that the logical channel priority with a smaller value may be of a higher priority.

It should be noted that combination of the above implementations may also be used.

When UCI of a PUCCH is multiplexed in a PUSCH overlapping the PUCCH, a first uplink grant associated with the PUSCH may be considered as a prioritized uplink grant, other overlapping uplink grants may be considered as de-prioritized uplink grants, and overlapping SR transmissions may be considered as de-prioritized SR transmissions, if the first uplink grant is not de-prioritized (e.g., based on logical channel prioritization) by another uplink grant associated with a PUSCH with a higher physical layer priority. In some implementations, when UCI of a PUCCH is multiplexed in a PUSCH overlapping the PUCCH, a first uplink grant associated with the PUSCH may be considered as a prioritized uplink grant, other overlapping uplink grants associated with PUSCHs with the same physical layer priority (or a lower physical layer priority) may be considered as de-prioritized uplink grants, and overlapping SR transmissions with the same physical layer priority (or a lower physical layer priority) may be considered as de-prioritized SR transmissions, if the first uplink grant is not de-prioritized (e.g., based on logical channel prioritization) by another uplink grant associated with a PUSCH with a higher physical layer priority.

When the first uplink grant and other overlapping uplink grants are all configured uplink grants, the first uplink grant may be at least one of a configured uplink grant with the smallest CG configuration index, a configured uplink grant in a serving cell with the smallest serving cell index, and a configured uplink grant with the associated PUSCH having the earliest starting symbol among CG configurations with the same physical layer priority. The first uplink grant may be a dynamic uplink grant when the other overlapping uplink grants are configured uplink grants. A MAC PDU may be generated for the first uplink grant (even) when there is no data (e.g., from logical channels) that may be multiplexed in the PUSCH associated with the first uplink grant. Padding bits may be included in the MAC PDU if no data is multiplexed in the MAC PDU. The generated MAC PDU may be delivered to a physical layer for transmission.

In some implementations, the first uplink grant may be a configured uplink grant satisfying the above conditions and not overlapping a dynamic uplink grant associated with a PUSCH with a different physical layer priority.

In some implementations, the MAC PDU including padding bits may be generated when an indication is received from a physical layer. The indication may be an (explicit) indication for multiplexing the PUCCH in the PUSCH. In some implementations, the indication may be indicated by the physical layer when no uplink grants associated with PUSCHs overlapping the PUSCH associated with the first configured uplink grant which satisfies a timeline requirement for overriding the first configured uplink grant are received. The timeline requirement for an uplink grant carried in DCI to override a configured uplink grant may be that the end of the DCI is T_{proc,2} before the start of the PUSCH associated with the configured uplink grant.

In some implementations, when physical layer prioritization of a low priority PUSCH by a high priority PUSCH is not supported, an overlapping uplink grant may prioritize over the first uplink grant based on logical channel prioritization when the MAC PDU of the first uplink grant has not been generated and when the physical layer priority of the overlapping uplink grant is higher than the physical layer priority of the first uplink grant. When the overlapping uplink grant is prioritized over the first uplink grant, the MAC PDU of the overlapping uplink grant may be generated and delivered to physical layer. In this case, the PUCCH overlapping the PUSCH associated with the first uplink grant may be transmitted if it is not overlapping the PUSCH associated with the overlapping uplink grant.

In some implementations, when physical layer prioritization of a low priority PUSCH by a high priority PUSCH is supported, an overlapping uplink grant may prioritize over the first uplink grant based on logical channel prioritization when the physical layer priority of the overlapping uplink grant is higher than the physical layer priority of the first uplink grant. When the overlapping uplink grant is prioritized over the first uplink grant, the MAC PDU of the overlapping uplink grant may be generated and delivered to a physical layer, and the physical layer may cancel the PUSCH transmission associated with the first uplink grant and prepare for the PUSCH transmission associated with the overlapping uplink grant. In this case, the PUCCH overlapping the PUSCH associated with the first uplink grant may be dropped. If the overlapping uplink grant is a dynamic uplink grant, the DCI carrying the dynamic grant should satisfy the timeline requirement for cancellation. The timeline requirement for cancellation for an uplink grant carried in a DCI to cancel a configured uplink grant may be that the end of the DCI is T_{proc,2}+d1 before the first overlapping symbol of the PUSCH associated with the configured grant and the PUSCH associated with the uplink grant carried in the DCI, where d1 may depend on UE capability.

In some implementations, a first uplink grant associated with a PUSCH with a first physical layer priority overlapping a PUCCH that is determined to be multiplexed in the PUSCH may be considered as a prioritized uplink grant, other overlapping uplink grants associated with PUSCHs with a physical layer priority the same as (or lower than) the physical layer priority may be considered as de-prioritized uplink grants, and overlapping SR transmissions with the same (or lower than) the physical layer priority may be considered as de-prioritized SR transmissions, if the first uplink grant is not de-prioritized based on logical channel prioritization by another uplink grant associated with a PUSCH with a higher physical layer priority.

In some implementations, a first uplink grant associated with a PUSCH overlapping a PUCCH with a physical layer priority that is determined to be multiplexed in the PUSCH may be considered as a prioritized uplink grant, other overlapping uplink grants associated with PUSCHs with a physical layer priority the same as (or lower than) the physical layer priority may be considered as de-prioritized uplink grants, and overlapping SR transmissions with the same (or lower than) the physical layer priority may be considered as de-prioritized SR transmissions, if the first uplink grant is not de-prioritized based on logical channel prioritization by another uplink grant associated with a PUSCH with a higher physical layer priority.

In some implementations, if a low priority PUSCH overlaps a high priority PUCCH that may prioritize the PUSCH, e.g., a high priority SR, the uplink grant associated with the low priority PUSCH may not be considered as a de-prioritized uplink grant before a UCI multiplexing procedure is performed on high priority PUCCHs if the UE supports multiplexing UCI of a high priority PUCCH in a low priority PUSCH. In some implementations, a de-prioritized uplink grant associated with a low priority PUSCH overlapping a high priority SR may be considered as a prioritized uplink grant based on logical channel prioritization if the high priority SR is multiplexed in a PUCCH not overlapping the low priority PUSCH after a UCI multiplexing procedure is performed on high priority PUCCHs.

Scheduling restriction may be used to avoid possibilities of dropping (or blocking) of high priority UCI or high priority PUSCH. For example, the possibilities may be a situation that the high priority UCI is dropped when the high priority UCI is multiplexed in a low priority PUSCH which is prioritized or cancelled by a high priority PUCCH.

The following implementations for scheduling restriction may be used in combination with the above implementations.

In some implementations, the UE may not expect a low priority PUSCH dynamically scheduled by the DCI to overlap a PUCCH and a high priority CG PUSCH.

In some implementations, the UE may not expect a low priority PUSCH dynamically scheduled by the DCI to overlap a PUCCH and a high priority CG PUSCH, if the low priority PUCCH is with starting symbol earlier than that of the low priority PUSCH. For example, the above scenario (e.g., illustrated in FIG. 4) may be scheduled only if the low priority HARQ-ACK has a starting symbol not earlier than the starting symbol of the low priority DG PUSCH. In some implementations, the restriction may be applicable when the UE does not support physical layer prioritization of a low priority PUSCH by a high priority PUSCH. With this scheduling restriction, when the high priority CG PUSCH is prioritized and the low priority DG PUSCH is de-prioritized, the low priority HARQ-ACK may be transmitted.

In some implementations, the UE may not expect a low priority PUSCH dynamically scheduled by the DCI to overlap a high priority PUCCH and a high priority CG PUSCH if the high priority PUCCH is determined to be multiplexed in the low priority PUSCH (e.g., based on the above described implementations).

In some implementations, the UE may not expect a low priority PUSCH dynamically scheduled by the DCI to overlap a high priority PUCCH and a high priority CG PUSCH if the high priority PUCCH is with starting symbol earlier than that of the low priority PUSCH, and if there is no indication of whether the high priority PUCCH is multiplexed in the low priority PUSCH. For example, the above scenario (e.g., illustrated in FIG. 6) may be scheduled only if the high priority HARQ-ACK has a starting symbol not earlier than the starting symbol of the low priority DG PUSCH. With this scheduling restriction, when high priority CG PUSCH is prioritized and the low priority DG PUSCH is de-prioritized, the high priority HARQ-ACK may be transmitted, and when the high priority CG PUSCH may be de-prioritized and the low priority DG PUSCH may be prioritized, the high priority HARQ-ACK may be transmitted (and the low priority DG PUSCH may be dropped) or the high priority HARQ-ACK may be multiplexed in the low priority PUSCH.

In some implementations, the UE may not expect a low priority PUSCH dynamically scheduled by the DCI to overlap a high priority CG PUSCH if the high priority CG PUSCH overlaps a high priority PUCCH, and if the low priority PUSCH overlaps a low priority PUCCH. For example, the above scenario (e.g., illustrated in FIG. 8) may not be expected by the UE.

In some implementations, the UE may not expect a low priority PUSCH dynamically scheduled by the DCI to overlap a high priority CG PUSCH if the high priority CG PUSCH overlaps a high priority PUCCH and if the CG PUSCH is the only CG PUSCH overlapping the high priority PUCCH, and if the low priority PUSCH overlaps a low priority PUCCH.

In some implementations, the UE may not expect a high priority PUCCH to be scheduled to overlap a high priority CG PUSCH if the high priority CG PUSCH overlaps a low priority PUSCH and the high priority CG PUSCH is later than the low priority PUSCH, and if the low priority PUSCH overlaps a low priority PUCCH. In some implementations, the restriction may be applicable when the UE does not support physical layer prioritization of a low priority PUSCH by a high priority PUSCH. For example, the above scenario (e.g., as illustrated in FIG. 9) may be scheduled if the UE supports the physical layer prioritization.

In some implementations, the UE may not expect a high priority PUCCH to be scheduled to overlap a high priority CG PUSCH if the high priority CG PUSCH overlaps a low priority DG PUSCH and the CG PUSCH is later than the low priority DG PUSCH. For example, the above scenario (e.g., as illustrated in FIG. 10) may not be expected by the UE. In some implementations, the restriction may be applicable when the UE does not support physical layer prioritization of a low priority PUSCH by a high priority PUSCH. In some implementations, the restriction may be applicable if the UCI multiplexing timeline (constraint) between the end of the DCI scheduling the high priority PUCCH and the start of the low priority DG PUSCH is not met.

In some implementations, the UE may not expect a high priority PUCCH to be scheduled to overlap a low priority PUSCH and a high priority PUSCH if the high priority PUCCH is multiplexed in the low priority PUSCH. For example, the above scenario (e.g., as illustrated in FIG. 11) may not be expected by the UE if the high priority PUCCH is multiplexed in the low priority DG PUSCH. In some implementations, the restriction may be applicable when the low priority PUSCH is a DG PUSCH and the high priority PUSCH is a CG PUSCH. In some implementations, the restriction may not be applicable when there is an (explicit) indication to multiplex the UCI(s) of the high priority PUCCH in which of the low priority PUSCH or the high priority PUSCH. In some implementations, the restriction may be applicable when the UE does not support physical layer prioritization of a low priority PUSCH by a high priority PUSCH. When physical layer prioritization is supported by the UE, if a high priority PUCCH is scheduled to overlap a low priority DG PUSCH and a high priority CG PUSCH (e.g., as illustrated in FIG. 11), the low priority DG PUSCH may be cancelled before the first overlapping symbol of the high priority CG PUSCH and the low priority CG PUSCH, and the high priority CG PUSCH may be transmitted with a multiplexed high priority PUCCH. In some implementations, when the UE does not support physical layer prioritization of a low priority PUSCH by a high priority PUSCH, if the UE is scheduled by the first DCI to transmit a high priority PUCCH that overlaps a low priority PUSCH scheduled by the second DCI earlier than the first DCI and also overlaps a high priority CG PUSCH, the low priority PUSCH may be cancelled before the first overlapping symbol of the high priority PUCCH and the low priority PUSCH, and the high priority PUCCH may be transmitted if a timeline requirement for cancellation is met between the low priority PUSCH and the high priority PUCCH. In some implementations, when the high priority PUCCH is determined to be multiplexed in the low priority PUSCH, the high priority CG PUSCH may not cancel (or disable) the low priority PUSCH when there is data available for being multiplexed in the CG PUSCH or when a MAC PDU is generated for the CG PUSCH. In some implementations, a high priority PUCCH overlapping a low priority PUSCH and a high priority CG PUSCH may be expected to have a starting symbol not earlier than the stating symbol of the low priority PUSCH.

In some implementations, the UE may not expect a low priority DG PUSCH to be scheduled to overlap a high priority PUCCH and a high priority CG PUSCH, if the high priority PUCCH may be multiplexed in the low priority DG PUSCH. In some implementations, the restriction may not be applicable when there is (explicit) indication to multiplex UCI(s) of the high priority PUCCH in which of the low priority PUSCH or the high priority PUSCH.

Multiplexing of High Priority HARQ-ACK (or SR) and Low Priority HARQ-ACK with a Specific Total Payload Size

When a low priority HARQ-ACK, a high priority HARQ-ACK and a high priority SR with the total payload size of 2 (or 3) bits are multiplexed in a PUCCH with PUCCH format 0 for low priority HARQ-ACK (or high priority HARQ-ACK), mapping of (values for) the low priority HARQ-ACK, the high priority HARQ-ACK and the high priority SR to sequence cyclic shift m_{CS} for PUCCH format 0 may be defined to ensure reliability of the high priority UCI(s).

When a PUCCH with PUCCH format 0 for low priority HARQ-ACK includes (only) 1 bit of low priority HARQ-ACK, 1 bit of high priority HARQ-ACK and 1 bit of high priority SR may be multiplexed in the PUCCH. Table 2 illustrates mapping of (values for) a low priority HARQ-ACK and a high priority HARQ-ACK to sequence cyclic shift m_{CS}.

TABLE 2

| | {HP HARQ-ACK, LP HARQ-ACK} | | | |
|---|---|---|---|---|
| | {0, 0} | {0, 1} | {1, 0} | {1, 1} |
| Sequence cyclic shift | m_{cs} = 2 | m_{cs} = 3 | m_{cs} = 8 | m_{cs} = 9 |

Table 2 may be used for mapping of the low priority HARQ-ACK, the high priority HARQ-ACK and a high priority SR to sequence cyclic shift m_{CS} for PUCCH format 0. Table 2 may be used if the high priority HARQ-ACK multiplexed in the PUCCH for high priority SR is then multiplexed in the PUCCH for low priority HARQ-ACK. For example, Table 2 may be used when the high priority HARQ-ACK in a PUCCH with PUCCH format 1 is multiplexed in a PUCCH with PUCCH format 1 for high priority SR, and the PUCCH for high priority SR overlaps the PUCCH for low priority HARQ-ACK.

Other mapping method(s) of the low priority HARQ-ACK and the high priority HARQ-ACK may be used if the following principle is used. For example, the cyclic shift(s) between different values of high priority HARQ-ACK under the condition of the same value of low priority HARQ-ACK is (separated by 6) cyclic shifts. The cyclic shift(s) between different values of low priority HARQ-ACK under the condition of the same value of high priority HARQ-ACK is separated by 1 cyclic shift. In some implementations, the high priority HARQ-ACK and the high priority SR may be multiplexed in the PUCCH with PUCCH format 0 for low priority HARQ-ACK if there is no PUCCH (resource) for low priority SR overlapping the PUCCH with PUCCH format 0 for low priority HARQ-ACK.

When a PUCCH with PUCCH format 0 for low priority HARQ-ACK includes (only) 1 bit of low priority HARQ-ACK, 1 bit of high priority SR may be multiplexed in the PUCCH. Table 3 illustrates mapping of (values for) a low priority HARQ-ACK and a high priority SR to sequence cyclic shift m_{CS}.

TABLE 3

| | {HP SR, LP HARQ-ACK} | | | |
|---|---|---|---|---|
| | {0, 0} | {0, 1} | {1, 0} | {1, 1} |
| Sequence cyclic shift | m_{cs} = 0 | m_{cs} = 1 | m_{cs} = 6 | m_{cs} = 7 |

Table 3 may be used for mapping of the low priority HARQ-ACK and the high priority SR to sequence cyclic shift m_{CS} for PUCCH format 0. In some implementations, the high priority SR may be multiplexed in the PUCCH with PUCCH format 0 for low priority HARQ-ACK if there is no PUCCH (resource) for low priority SR overlapping the PUCCH with PUCCH format 0 for low priority HARQ-ACK.

When a PUCCH with PUCCH format 0 for high priority HARQ-ACK includes (only) 1 bit of high priority HARQ-ACK and overlaps (only) one PUCCH (resource) for high priority SR, if the PUCCH with PUCCH format 0 for high priority HARQ-ACK overlaps a PUCCH (resource) carrying 1 bit of low priority HARQ-ACK, 1 bit of high priority HARQ-ACK, 1 bit of high priority SR, and 1 bit of low priority HARQ-ACK may be multiplexed in the PUCCH with PUCCH format 0 for high priority HARQ-ACK. Table 4 illustrates mapping of (values for) a high priority HARQ-ACK and a high priority SR to sequence cyclic shift m_{CS} when a value of a low priority HARQ-ACK is 0. Table 5 illustrates mapping of (values for) a high priority HARQ-ACK and a high priority SR to sequence cyclic shift m_{CS} when a value of a low priority HARQ-ACK is 1.

TABLE 4

| | {HP SR, HP HARQ-ACK} | | | |
|---|---|---|---|---|
| | {0, 0} | {0, 1} | {1, 0} | {1, 1} |
| Sequence cyclic shift | m_{cs} = 0 | m_{cs} = 3 | m_{cs} = 6 | m_{cs} = 9 |

TABLE 5

| | {HP SR, HP HARQ-ACK} | | | |
|---|---|---|---|---|
| | {0, 0} | {0, 1} | {1, 0} | {1, 1} |
| Sequence cyclic shift | m_{cs} = 1 | m_{cs} = 4 | m_{cs} = 7 | m_{cs} = 10 |

Table 4 and Table 5 may be used for mapping of the low priority HARQ-ACK, the high priority HARQ-ACK, and the high priority SR to sequence cyclic shift m_{CS} for PUCCH format 0. In some implementations, bit position of the high priority HARQ-ACK and bit position of the high priority SR may be reversed.

When a PUCCH with PUCCH format 0 for high priority HARQ-ACK includes (only) 1 bit of high priority HARQ-ACK and does not overlap PUCCH(s) (resources) for high priority SR, if the PUCCH with PUCCH format 0 for high priority HARQ-ACK overlaps a PUCCH (resource) carrying 1 bit of low priority HARQ-ACK, 1 bit of high priority HARQ-ACK and 1 bit of low priority HARQ-ACK may be multiplexed in the PUCCH with PUCCH format 0 for high priority HARQ-ACK. Table 6 illustrates mapping of (values for) a low priority HARQ-ACK and a high priority HARQ-ACK to sequence cyclic shift m_{CS}.

TABLE 6

| | {LP HARQ-ACK, HP HARQ-ACK} | | | |
|---|---|---|---|---|
| | {0, 0} | {0, 1} | {1, 0} | {1, 1} |
| Sequence cyclic shift | m_{cs} = 0 | m_{cs} = 6 | m_{cs} = 1 | m_{cs} = 7 |

Table 6 may be used for mapping of the low priority HARQ-ACK and the high priority HARQ-ACK to sequence cyclic shift m_{CS} for PUCCH format 0.

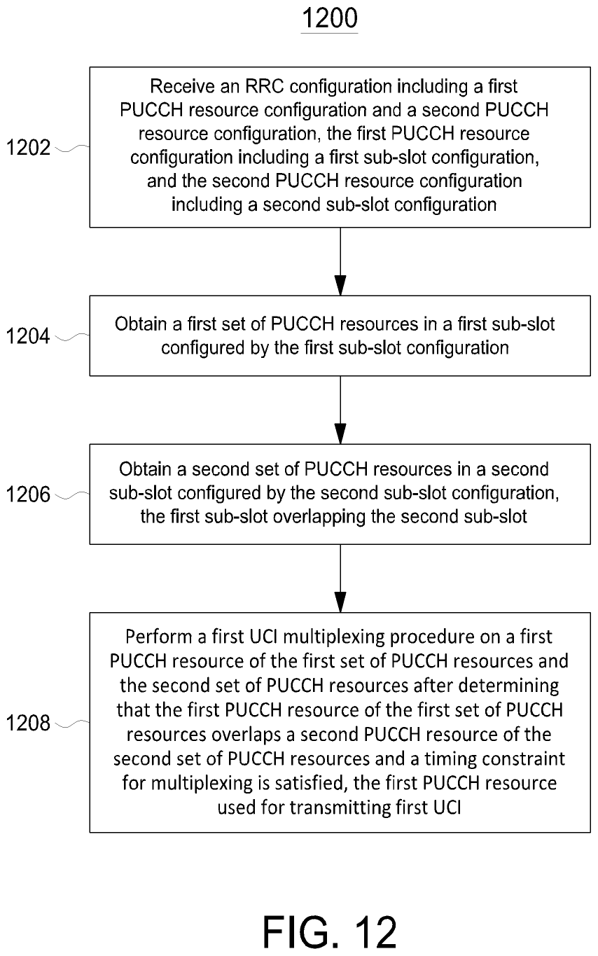

FIG. 12 is a flowchart illustrating a method 1200 performed by a UE for multiplexing UCI, according to an example implementation of the present disclosure. In action 1202, the UE receives an RRC configuration including a first PUCCH resource configuration and a second PUCCH resource configuration, the first PUCCH resource configuration including a first sub-slot configuration, and the second PUCCH resource configuration including a second sub-slot configuration. In action 1204, the UE obtains a first set of PUCCH resources in a first sub-slot configured by the first sub-slot configuration. In action 1206, the UE obtains a second set of PUCCH resources in a second sub-slot configured by the second sub-slot configuration, the first sub-slot overlapping the second sub-slot. In action 1208, the UE performs a first UCI multiplexing procedure on a first PUCCH resource of the first set of PUCCH resources and the second set of PUCCH resources after (e.g., in response to) determining that the first PUCCH resource of the first set of PUCCH resources overlaps a second PUCCH resource of the second set of PUCCH resources and a timing constraint for multiplexing is satisfied, the first PUCCH resource used for transmitting first UCI. The first UCI multiplexing procedure includes selecting a third PUCCH resource from the second set of PUCCH resources, the third PUCCH resource used for transmitting second UCI; and multiplexing the first UCI and the second UCI in the third PUCCH resource. A set of PUCCH resources on which the UCI multiplexing procedure (e.g., the first PUCCH resource and the second set of PUCCH resources) is performed may be referred to as a set Q.

In some implementations, the first PUCCH resource configuration may be associated with a low priority, and the second PUCCH resource configuration may be associated with a high priority.

In some implementations, the first UCI may include at least one of CSI, an SR with a low priority, and HARQ-ACK information associated with the first PUCCH resource configuration.

In some implementations, the second UCI may include at least one of an SR with a high priority and HARQ-ACK information associated with the second PUCCH resource configuration.

In some implementations, the first set of PUCCH resources may not overlap each other. In some implementations, the first set of PUCCH resources may be obtained by performing a second UCI multiplexing procedure on a set of PUCCH resources associated with a low priority in the first sub-slot.

In some implementations, the second set of PUCCH resources may not overlap each other. In some implementations, the second set of PUCCH resources may be obtained by performing a second UCI multiplexing procedure on a set of PUCCH resources associated with a high priority in the second sub-slot.

In some implementations, the first PUCCH resource may have a starting symbol within the second sub-slot.

In some implementations, the first UCI multiplexing procedure may further be performed on a fourth PUCCH resource of the first set of PUCCH resources, the fourth PUCCH resource may be used for transmitting third UCI and may have a starting symbol within the second sub-slot. The first UCI multiplexing procedure may further include determining whether to multiplex the third UCI in the third PUCCH resource (or one of the second set of PUCCH resources) according to whether the fourth PUCCH resource overlaps the third PUCCH resource (or one of the second set of PUCCH resources). In some implementations, the UE may multiplex the third UCI in the third PUCCH resource in a case that the fourth PUCCH resource overlaps the third PUCCH resource. In some implementations, the UE may cancel (or disable) multiplexing the third UCI in the third PUCCH resource in a case that the fourth PUCCH resource does not overlap the third PUCCH resource. It should be noted that the third UCI may not be multiplexed in one of the second set of PUCCH resources after performing the first UCI multiplexing procedure.

In some implementations, the UE may obtain a third set of PUCCH resources in a third sub-slot configured by the second sub-slot configuration, the third sub-slot being after the second sub-slot, and the third sub-slot overlapping the first sub-slot. The UE may perform a second UCI multiplexing procedure for a fourth PUCCH resource of the first set of PUCCH resources and the third set of PUCCH resources after determining that the fourth PUCCH resource overlaps a fifth PUCCH resource of the third set of PUCCH resources, the fourth PUCCH resource used for transmitting third UCI. The second UCI multiplexing procedure includes selecting a sixth PUCCH resource from the third set of PUCCH resources, the sixth PUCCH resource used for transmitting fourth UCI; and multiplexing the third UCI and the fourth UCI in the sixth PUCCH resource. In some implementations, the third UCI may not be dropped or multiplexed in one of the second set of PUCCH resources after performing the first UCI multiplexing procedure.

In some implementations, the UE may multiplex the first UCI and the second UCI in a PUSCH resource associated with a low priority after determining that the third PUCCH resource overlaps the PUSCH resource. That is, the UCI of the high priority PUCCH resource may be multiplexed in the PUSCH resource after performing the UCI multiplexing procedure on the high priority PUCCH resource and the low priority PUCCH resource. In some implementations, DCI scheduling the PUSCH resource may indicate that the second UCI is multiplexed in the PUSCH resource.

In some implementations, the timing constraint for multiplexing may be satisfied in a case that a time duration between reception of DCI that schedules a fourth PUCCH resource of the second set of PUCCH resources and the first PUCCH resource is larger than a predefined time duration.

In some implementations, the UE may drop the first UCI after determining that the first PUCCH resource of the first set of PUCCH resources overlaps the second PUCCH resource of the second set of PUCCH resources and the timing constraint for multiplexing is not satisfied.

It should be noted that actions 1204 and 1206 should not be construed as necessarily order dependent on their performance. The order in which the process is described is not intended to be construed as a limitation, and any number of the described actions may be combined in any order to implement the method or an alternate method. Moreover, one or more of the actions illustrated in FIG. 12 may be omitted in some implementations.

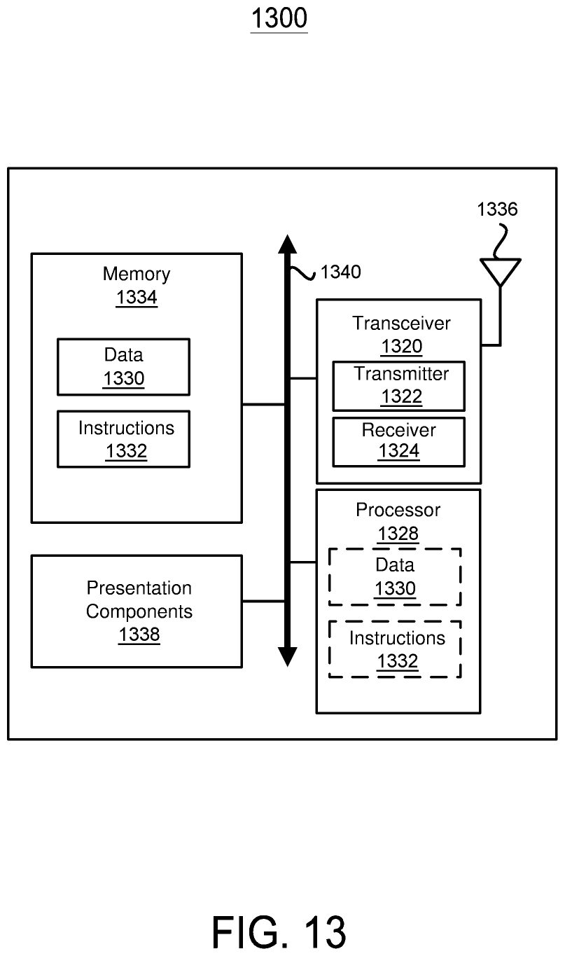

FIG. 13 is a block diagram illustrating a node 1300 for wireless communication according to an example implementation of the present disclosure. As illustrated in FIG. 13, a node 1300 may include a transceiver 1320, a processor 1328, a memory 1334, one or more presentation components 1338, and at least one antenna 1336. The node 1300 may also include a RF spectrum band module, a BS communications module, a network communications module, and a system communications management module, Input/Output (I/O) ports, I/O components, and a power supply (not illustrated in FIG. 13).

Each of the components may directly or indirectly communicate with each other over one or more buses 1340. The node 1300 may be a UE or a BS that performs various functions disclosed with reference to FIGS. 1 through 12.

The transceiver 1320 has a transmitter 1322 (e.g., transmitting/transmission circuitry) and a receiver 1324 (e.g., receiving/reception circuitry) and may be configured to transmit and/or receive time and/or frequency resource partitioning information. The transceiver 1320 may be configured to transmit in different types of subframes and slots including but not limited to usable, non-usable and flexibly usable subframes and slot formats. The transceiver 1320 may be configured to receive data and control channels.

The node 1300 may include a variety of computer-readable media. Computer-readable media may be any available media that may be accessed by the node 1300 and include both volatile and non-volatile media, removable and non-removable media.

The computer-readable media may include computer storage media and communication media. Computer storage media include both volatile and non-volatile, removable and non-removable media implemented in any method or technology for storage of information such as computer-readable instructions, data structures, program modules or data.

Computer storage media include RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media do not include a propagated data signal. Communication media typically embody computer-readable instructions, data structures, program modules or other data in a modulated data signal such as a carrier wave or other transport mechanism and include any information delivery media.

The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the previously listed components should also be included within the scope of computer-readable media.

The memory 1334 may include computer-storage media in the form of volatile and/or non-volatile memory. The memory 1334 may be removable, non-removable, or a combination thereof. Example memory includes solid-state memory, hard drives, optical-disc drives, etc. As illustrated in FIG. 13, the memory 1334 may store computer-readable, computer-executable instructions 1332 (e.g., software codes) that are configured to cause the processor 1328 to perform various disclosed functions, for example, with reference to FIGS. 1 through 12. Alternatively, the instructions 1332 may not be directly executable by the processor 1328 but be configured to cause the node 1300 (e.g., when compiled and executed) to perform various disclosed functions.

The processor 1328 (e.g., having processing circuitry) may include an intelligent hardware device, e.g., a Central Processing Unit (CPU), a microcontroller, an ASIC, etc. The processor 1328 may include memory. The processor 1328 may process data 1330 and the instructions 1332 received from the memory 1334, and information transmitted and received via the transceiver 1320, the base band communications module, and/or the network communications module. The processor 1328 may also process information to be sent to the transceiver 1320 for transmission via the antenna 1336 to the network communications module for transmission to a core network.

One or more presentation components 1338 present data indications to a person or another device. Examples of presentation components 1338 include a display device, a speaker, a printing component, and a vibrating component, etc.

In view of the present disclosure, it is obvious that various techniques may be used for implementing the concepts in the present disclosure without departing from the scope of those concepts. Moreover, while the concepts have been disclosed with specific reference to certain implementations, a person of ordinary skill in the art will recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method performed by a User Equipment (UE) for multiplexing Uplink Control Information (UCI), the method comprising:
receiving a Radio Resource Control (RRC) configuration including a first Physical Uplink Control Channel (PUCCH) resource configuration and a second PUCCH resource configuration, the first PUCCH resource configuration including a first sub-slot configuration and the second PUCCH resource configuration including a second sub-slot configuration;
obtaining a first set of PUCCH resources in a first sub-slot configured by the first sub-slot configuration;
obtaining a second set of PUCCH resources in a second sub-slot configured by the second sub-slot configuration, the first sub-slot overlapping the second sub-slot; and
performing a first UCI multiplexing procedure after determining that a first PUCCH resource of the first set of PUCCH resources overlaps a second PUCCH resource of the second set of PUCCH resources and a timing constraint for multiplexing is satisfied, the first PUCCH resource being associated with transmission of first UCI,
wherein the first UCI multiplexing procedure comprises:
selecting a third PUCCH resource from the second set of PUCCH resources, and
multiplexing the first UCI in the third PUCCH resource.

2. The method of claim 1, wherein the first PUCCH resource configuration has a low priority, and the second PUCCH resource configuration has a high priority.

3. The method of claim 1, wherein the first UCI includes at least one of Channel State Information (CSI), a Scheduling Request (SR) with a low priority, and Hybrid Automatic Repeat reQuest (HARQ)-Acknowledgement (ACK) information associated with the first PUCCH resource configuration.

4. The method of claim 1, wherein:
the third PUCCH resource is associated with transmission of second UCI, and
the second UCI includes at least one of a Scheduling Request (SR) with a high priority and Hybrid Automatic Repeat reQuest (HARQ)-Acknowledgement (ACK) information associated with the second PUCCH resource configuration.

5. The method of claim 1, wherein the first set of PUCCH resources is obtained by performing a second UCI multiplexing procedure on a third set of PUCCH resources having a low priority in the first sub-slot.

6. The method of claim 1, wherein the second set of PUCCH resources is obtained by performing a second UCI multiplexing procedure on a third set of PUCCH resources having a high priority in the second sub-slot.

7. The method of claim 1, wherein the first PUCCH resource has a starting symbol within the second sub-slot.

8. The method of claim 1, wherein the first UCI multiplexing procedure is further performed on a fourth PUCCH resource of the first set of PUCCH resources, the fourth PUCCH resource being associated with transmission of third UCI and having a starting symbol within the second sub-slot, wherein the first UCI multiplexing procedure further comprises:
determining whether to multiplex the third UCI in the third PUCCH resource based on whether the fourth PUCCH resource overlaps the third PUCCH resource.

9. The method of claim 1, further comprising:
obtaining a third set of PUCCH resources in a third sub-slot configured by the second sub-slot configuration, the third sub-slot being after the second sub-slot and overlapping the first sub-slot; and
performing a second UCI multiplexing procedure after determining that a fourth PUCCH resource overlaps a fifth PUCCH resource of the third set of PUCCH resources, the fourth PUCCH resource being associated with transmission of third UCI,
wherein the second UCI multiplexing procedure comprises:
selecting a sixth PUCCH resource from the third set of PUCCH resources, the sixth PUCCH resource being associated with transmission of fourth UCI, and
multiplexing the third UCI and the fourth UCI in the sixth PUCCH resource.

10. The method of claim 9, wherein the third UCI is not dropped or multiplexed in one of the second set of PUCCH resources after performing the first UCI multiplexing procedure.

11. The method of claim 1, wherein:
the third PUCCH resource is associated with transmission of second UCI, the method further comprising:
multiplexing the first UCI and the second UCI in a Physical Uplink Shared Channel (PUSCH) resource associated with a low priority after determining that the third PUCCH resource overlaps the PUSCH resource.

12. The method of claim 11, wherein Downlink Control Information (DCI) scheduling the PUSCH resource indicates that the second UCI is multiplexed in the PUSCH resource.

13. The method of claim 1, wherein the timing constraint for multiplexing is satisfied in a case that a time duration between reception of Downlink Control Information (DCI) that schedules a fourth PUCCH resource of the second set of PUCCH resources and the first PUCCH resource is larger than a predefined time duration.

14. The method of claim 1, further comprising:
dropping the first UCI after determining that the first PUCCH resource of the first set of PUCCH resources overlaps the second PUCCH resource of the second set of PUCCH resources and the timing constraint for multiplexing is not satisfied.

15. A user equipment (UE) for multiplexing Uplink Control Information (UCI), the UE comprising:
at least one processor; and
at least one memory coupled to the at least one processor, wherein the at least one memory stores one or more computer-executable instructions that, when executed by the at least one processor, cause the UE to:
receive a Radio Resource Control (RRC) configuration including a first Physical Uplink Control Channel (PUCCH) resource configuration and a second PUCCH resource configuration, the first PUCCH resource configuration including a first sub-slot configuration, and the second PUCCH resource configuration including a second sub-slot configuration;
obtain a first set of PUCCH resources in a first sub-slot configured by the first sub-slot configuration;
obtain a second set of PUCCH resources in a second sub-slot configured by the second sub-slot configuration, the first sub-slot overlapping the second sub-slot; and
perform a first UCI multiplexing procedure after determining that a first PUCCH resource of the first set of PUCCH resources overlaps a second PUCCH resource of the second set of PUCCH resources and a timing constraint for multiplexing is satisfied, the first PUCCH resource being associated with transmission of first UCI,
wherein the first UCI multiplexing procedure comprises:
selecting a third PUCCH resource from the second set of PUCCH resources, and
multiplexing the first UCI in the third PUCCH resource.

16. The UE of claim 15, wherein the first PUCCH resource configuration has a low priority, and the second PUCCH resource configuration has a high priority.

17. The UE of claim 15, wherein:
the third PUCCH resource is associated with transmission of second UCI,
the first UCI includes at least one of Channel State Information (CSI), a Scheduling Request (SR) with a low priority, and Hybrid Automatic Repeat reQuest (HARQ)-Acknowledgement (ACK) information associated with the first PUCCH resource configuration, and
the second UCI includes at least one of an SR with a high priority and HARQ-ACK information associated with the second PUCCH resource configuration.

18. The UE of claim 15, wherein:
the first set of PUCCH resources is obtained by performing a second UCI multiplexing procedure on a third set of PUCCH resources having a low priority in the first sub-slot, and
the second set of PUCCH resources is obtained by performing a second UCI multiplexing procedure on a fourth set of PUCCH resources having a high priority in the second sub-slot.

19. The UE of claim 15, wherein the first PUCCH resource has a starting symbol within the second sub-slot.

20. The UE of claim 15, wherein the first UCI multiplexing procedure is further performed on a fourth PUCCH resource of the first set of PUCCH resources, the fourth PUCCH resource being associated with transmission of third UCI and having a starting symbol within the second sub-slot, wherein the first UCI multiplexing procedure further comprises:
determining whether to multiplex the third UCI in the third PUCCH resource based on whether the fourth PUCCH resource overlaps the third PUCCH resource.
